(19) United States
(12) Patent Application Publication
(10) Pub. No.: US 2015/0155537 A1
(43) Pub. Date: Jun. 4, 2015

(54) IONOMER COMPOSITE MEMBRANES, METHODS FOR MAKING AND METHODS FOR USING

(71) Applicant: E. I. DU PONT DE NEMOURS AND COMPANY, Wilmington, DE (US)

(72) Inventors: Kostantinos Kourtakis, Media, PA (US); Vivek Kapur, Kennett Square, PA (US); Glen E. Simmonds, Avondale, PA (US)

(21) Appl. No.: 14/409,282

(22) PCT Filed: Apr. 4, 2013
(86) PCT No.: PCT/US2013/035225

§ 371 Date: Dec. 18, 2014

Related U.S. Application Data
(60) Provisional application No. 61/661,495, filed on Jun. 19, 2012.

(51) Int. Cl. H01M 2/16; H01M 10/052; H01M 2/14; H01M 2/02

(52) U.S. Cl. CPC H01M 2/162; H01M 2/02; H01M 2/0202; H01M 2/0237; H01M 10/052; H01M 2/145; H01M 2220/30; H01M 2220/20

(57) ABSTRACT

There is an ionomer composite membrane comprising at least one laterally adjacent region and laterally isolated regions occupying about 0.1 to 80% by volume of the membrane and associated with pores having an average pore diameter dimension of about 0.1 to 150 microns. The membrane has an average thickness of about 3 to 500 microns and comprises a first material and a second material. A first region in the membrane comprises the first material and a second region comprises the second material. The first material comprises an ionomer. There is also a cell including the membrane. There also are related methods of making and using the membrane and cell.

### CROSS-REFERENCE TO RELATED APPLICATIONS

This application claims priority to and the benefit of the filing date of U.S. Provisional Application Nos. 61/661,495, filed on Jun. 19, 2012, the entirety of which is herein incorporated by reference.

### BACKGROUND

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A common limitation of previously-developed Li—S cells and batteries is capacity degradation or capacity “fade”. Capacity fade is associated with coulombic efficiency, the fraction or percentage of the electrical charge stored by charging that is recoverable during discharge. It is generally believed that capacity fade and coulombic efficiency are due, in part, to sulfur loss through the formation of certain soluble sulfur compounds which “shuttle” between electrodes in a Li—S cell and react to deposit on the surface of a negative electrode in a Li—S cell. It is believed that these deposited sulfides can obstruct and otherwise foul the surface of the negative electrode and may also result in sulfur loss from the total electroactive sulfur in the cell. The formation of anode-deposited sulfur compounds involves complex chemistry which is not completely understood.

In addition, low coulombic efficiency is another common limitation of Li—S cells and batteries. A low coulombic efficiency can be accompanied by a high self-discharge rate. It is believed that low coulombic efficiency is also a consequence, in part, of the formation of the soluble sulfur compounds which shuttle between electrodes during charge and discharge processes in a Li—S cell.

Some previously-developed Li—S cells and batteries have utilized high loadings of sulfur compound in their positive electrodes in attempting to address the drawbacks associated with capacity degradation and anode-deposited sulfur compounds. However, simply utilizing a higher loading of sulfur compound presents other difficulties, including a lack of adequate containment for the entire amount of sulfur compound in the high loading. Furthermore, positive electrodes formed using these compositions tend to crack or break. Another difficulty may be due, in part, to the insulating effect of the higher loading of sulfur compound. The insulating effect may contribute to difficulties in realizing the full capacity associated with all the potentially electroactive sulfur in the high loading of sulfur compound in a positive electrode of these previously-developed Li—S cell and batteries.

Conventionally, the lack of adequate containment for a high loading of sulfur compound has been addressed by utilizing higher amounts of binder in compositions incorporated into these positive electrodes. However, a positive electrode incorporating a high binder amount tends to have a lower sulfur utilization which, in turn, lowers the effective maximum discharge capacity of the Li—S cells with these electrodes.

Li—S cells and batteries are desirable based on the high theoretical capacities and high theoretical energy densities of the electroactive sulfur in their positive electrodes. However, attaining the full theoretical capacities and energy densities remains elusive. Furthermore, as mentioned above, the sulfide shuttling phenomena present in Li—S cells (i.e., the movement of polysulfides between the electrodes) can result in relatively low coulombic efficiencies for these electrochemical cells; and this is typically accompanied by undesirably high self-discharge rates. In addition, the concomitant limitations associated with capacity degradation, anode-deposited sulfur compounds and the poor conductivities intrinsic to sulfur compound itself, all of which are associated with previously-developed Li—S cells and batteries, limits the application and commercial acceptance of Li—S batteries as power sources.

Given the foregoing, what are needed are Li—S cells and batteries without the above-identified limitations of previously-developed Li—S cells and batteries.

### BRIEF SUMMARY

This summary is provided to introduce a selection of concepts. These concepts are further described below in the detailed description in conjunction with the accompanying drawings. This summary is not intended to identify key features or essential features of the claimed subject matter, nor is this summary intended as an aid in determining the scope of the claimed subject matter.

The disclosure hereof meets the above-identified needs by providing Li—S cells incorporating ionomer articles, such as ionomer composite (IC) membranes. An IC membrane may be described, generally, as a membrane having a membrane structure that is delineated according to one or more structural parameters and incorporates one or more types of ion-containing polymer materials, such as ionomers, situated within at least a part of the membrane structure. An IC membrane structure may be quantified based on one or more structural parameters, such as the external dimensions of the membrane, and/or other parameters, such as the size and shape of ionomer containing channels. Examples of several IC membranes are further described below in the detailed description and with respect to the drawings.

IC membranes provide Li—S cells and batteries with high coulombic efficiencies and without the above-identified limitations of previously-developed Li—S cells and batteries. In some embodiments, IC membranes may also provide Li—S cells and batteries with high maximum discharge capacities.

According to an embodiment, a membrane structure of an IC membrane may permit the incorporation of limited or controlled amount of ion-containing polymer materials having ion groups incorporated into the polymers, such as ionomers. The ionomers may be incorporated into localized regions of the IC membrane structure. In an example according this embodiment, a specific type of ion-containing polymer material, which may be very expensive or have other limitations, may be more effectively utilized. The IC membrane may be constructed using a process, such as a fiber-on-end (FOE) process, which provides precise control over the structural parameters associated with the IC membrane, such as pore dimensions, pore locations, pore distribution and the like.

In addition to ion-containing polymer materials, an IC membrane may also incorporate other polymeric materials that do not have ion groups incorporated into the polymers. These other polymeric materials may be incorporated into an IC membrane in various ways, such as in a combination by blending the other polymeric material with an ionomer and incorporating the blend into a localized region. Alternatively, the other polymeric material may be in a distinct region of an IC membrane which contains no ion-containing polymer material. Or in both types of regions. Non-ion-containing polymer materials may be selected and incorporated into various locations in an IC membrane for the physical and/or chemical properties which these materials impart to the membrane.

An IC membrane, according to the principles of the disclosure hereof, may provide a Li—S cell with surprisingly high coulombic efficiencies and very high ratios of discharge to charge capacity. While not being bound by any particular theory, it is believed that the ionomer in an IC membrane suppresses the shuttling of soluble sulfur compounds through a cell's electrolyte medium, thus inhibiting their arrival at a negative electrode in the Li—S cell. Thus, the IC membrane reduces capacity fade through sulfur loss in the cell and self-discharges by the cell.

These and other objects are accomplished through IC membranes, Li—S cells comprising an IC membrane, methods for making and methods for using such in accordance with the principles of the disclosure hereof.

According to a first principle of the disclosure hereof, there is an ionomer composite (IC) membrane. The IC membrane has an average thickness of about 3 to 500 microns and comprises a first material and a second material. The IC membrane comprises at least one laterally adjacent region (LAR) and a plurality of laterally isolated regions (LIRs) occupying about 0.1 to 80% by volume of the membrane. The LIRs are associated with pores having an average pore diameter dimension of about 0.1 to 150 microns. The IC membrane comprises a first material and a second material. A first region in the IC membrane comprises the first material and a second region comprises the second material. The first material comprises an ionomer.

According to a second principle of the disclosure hereof, there is a method for making an IC membrane. The method comprises providing a set of multicomponent fibers. The fibers in the set have at least one center area associated with an average diameter dimension of about 0.1 to 150 microns. The set of multicomponent fibers comprises about 20 to 99.9% by volume of at least one fiber material located around the at least one center area of respective fibers in the set, and about 0.1 to 80% by volume of at least one sacrificial material located within the at least one center area of the respective fibers in the set. The method includes fusing the set of fibers to form a billet and skiving the billet to form a composite sheet having an average thickness of about 3 to 500 microns. The method includes removing the sacrificial material from the skived composite sheet to form a vacated composite sheet with pores having an average pore diameter dimension of about 0.1 to 150 microns and introducing a filling material into the pores of the vacated composite sheet. At least one of the fiber material and the filling material comprises an ionomer.

According to a third principle of the disclosure hereof, there is a method for using an IC membrane. The method comprises exposing at least a first side of the membrane to a medium comprising soluble sulfur compounds and lithium ions and applying an electric current to the medium. The method includes substantially permitting the passage of lithium ions from the first side to a second side of the membrane and substantially inhibiting the passage of soluble sulfur compounds from the first side to the second side of the membrane.

According to a fourth principle of the disclosure hereof, there is a cell comprising a positive electrode, a negative electrode, a circuit coupling the positive electrode with the negative electrode, an electrolyte medium, an interior wall of the cell and an ionomer composite membrane comprising an ionomer. The membrane is characterized as having a plurality of laterally isolated regions occupying about 0.1 to 80% by volume of the membrane and associated with pores having an average pore diameter dimension of about 0.1 to 150 microns and at least one laterally adjacent region.

According to a fifth principle of the disclosure hereof, there is a method for making a cell. The method comprises providing an ionomer composite membrane comprising an ionomer and fabricating the cell by combining the ionomer composite membrane with other components to form the cell. The other components include a positive electrode, a negative electrode, a circuit coupling the positive electrode with the negative electrode, an electrolyte medium, and an interior wall of the cell.

According to a sixth principle of the disclosure hereof, there is a method for using a cell. The method comprises at least one step from the plurality of steps comprising converting chemical energy stored in the cell into electrical energy and converting electrical energy into chemical energy stored in the cell. The cell comprises a positive electrode, a negative electrode, a circuit coupling the positive electrode with the negative electrode, an electrolyte medium, an interior wall of the cell and an ionomer composite membrane comprising an ionomer.

The above summary is not intended to describe each embodiment or every implementation of the present disclosure hereof. Further features, their nature and various advantages are described in the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the figures in the drawings highlight the aspects, methodology, functionality and advantages of the present invention, and are presented for example purposes only. The present invention is sufficiently flexible such that it may be implemented in ways other than shown in the accompanying figures.

FIG. 1A is a schematic drawing of a frontal view of a surface of an IC membrane, according to an example;

FIG. 1B is a schematic drawing of a frontal view of a laterally isolated region on a surface of an IC membrane, according to an example;

FIG. 2 is a flow diagram describing a method for making an IC membrane according to a fiber-on-end (FOE) process, according to an example;

FIG. 3 is a two-dimensional perspective of a Li—S cell incorporating several IC membranes, according to an example;

FIG. 4 is a context diagram illustrating properties of a Li—S battery including a Li—S cell incorporating an IC membrane, according to an example; and

FIG. 5 is a two-dimensional perspective of a Li—S coin cell incorporating an IC membrane, according to an example.

### DETAILED DESCRIPTION

The present inventions are useful for certain energy storage applications, and has been found to be particularly advantageous for high maximum discharge capacity batteries which operate with high coulombic efficiency utilizing electrochemical voltaic cells which derive electrical energy from chemical reactions involving sulfur compounds. While the present inventions are not necessarily limited to such applications, various aspects of the invention are appreciated through a discussion of various examples using this context.

For simplicity and illustrative purposes, the present inventions are described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of these embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and/or their equivalents. The significance of the examples may be better understood by comparing the results obtained therefrom with potential results which may be obtained from tests or trials that may be, or may have been, designed to serve as controlled experiments and to provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

The meaning of abbreviations and certain terms used herein is as follows: “A” means angstrom(s), “μm” means micrometer(s) or micron(s), “g” means gram(s), “mg” means milligram(s), “μg” means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in 1/x hours, “SOC” means state of charge, “SEI” means solid electrolyte interface formed on the surface of an electrode material, “kPa” means kilopascal(s), “rpm” means revolutions per minute, and “psi” means pounds per square inch.

The term “maximum discharge capacity” is the maximum milliamp hour(s) per gram of a positive electrode in a Li—S cell at the beginning of a discharge phase (i.e., maximum charge capacity on discharge), “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., Vp) is the sum of the volumes of all the pores in one gram of a substance and may be expressed as cc/g, “porosity” (i.e., “void fraction”) is either the fraction (0-1) or the percentage (0-100%) expressed by the ratio: (volume of voids in a substance)/(total volume of the substance).

As used herein and unless otherwise stated the term “cathode” is used to identify a positive electrode and “anode” to identify the negative electrode of a battery or cell. The term “battery” is used to denote a collection of one or more cells arranged to provide electrical energy. The cells of a battery can be arranged in various configurations (e.g., series, parallel and combinations thereof).

The term “sulfur compound” as used herein refers to any compound that includes at least one sulfur atom, such as elemental sulfur and other sulfur compounds, such as lithiated sulfur compounds including disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al., J. Electrochem. Soc., Vol. 144, No. 6, pp. L170-L172 (June 1997), which is incorporated herein by reference in its entirety.

The term “ionomer”, as used herein, refers to any polymer including an ionized functional group (e.g., sulfonic acid, phosphonic acid, phosphoric acid or carboxylic acid, such as acrylic or methacrylic acid (i.e., “(meth)acrylic acid”) in which the acid group is neutralized with a base including an alkali metal, such as lithium, to form an ionized functionality, such as lithium methacrylate). The term “ionomer” may also refer to a combination of ion-containing polymer materials, such as an ionomer blend, unless a use of the term indicates otherwise, such as through the context within which it is used. The term “halogen ionomer”, as used herein, refers to any ionomer including at least one halogen atom (i.e., fluorine (F), chlorine (Cl), bromine (Br), iodine (I), and Astatine (At)) incorporated by a covalent bond into a site (e.g., the polymer backbone or branching) on the ionomer. The term “hydrocarbon ionomer”, as used herein, refers to any ionomer not including any halogen atoms incorporated by a covalent bond into a site (e.g., the polymer backbone or branching) on the ionomer.

The term “fibers-on-end” (FOE) as used herein refers to an arrangement of fibers substantially all of which are parallel to a common axis and perpendicular to an optional processing means. The term “fibers-on-end (FOE) process” refers to a process utilized for making “fibers-on-end.” In an embodiment, a plurality of fibers may be arranged parallel to each other and formed into a fused group, which may retain the parallel fiber orientation, or another orientation as desired. The fused group forms a solid block of material, or “billet.” As used herein, the term “billet” refers to a semi-finished solid material comprising fused multicomponent fibers. The fibers may be bound together by thermal fusing of the fibers, or by other means, such as by coating the fibers with a binder or by solvent bonding. As used herein, the term “fiber” means any material with slender, elongated structure such as polymer or natural fibers. A fiber is generally characterized by having a length at least 100 times its diameter or width, although longer or shorter lengths may also be characterized as fibers.

A fused solid “billet” may be formed in a “FOE process” and then be further processed by removing a thin layer from the billet, typically though not necessarily perpendicular to the fiber orientation, with a sharp blade thus forming a membrane. This process is known as “skiving.” The term “membrane” as used herein is a discrete thin structure that can moderate the transport of species in contact with it, such as molecules or particulates in a medium such as a gas, vapor, aerosol and/or liquid. Thicker sections may be desired to replicate the thickness of films and their distinctive end-uses, and still thicker may be used if desired.

The term “lithium transport separator” as used herein refers to a selective separator, capable of transporting lithium ions, while moderating other species, such as polysulfides. A lithium transport separator may include an IC membrane which may be formed in different ways, such as in a FOE process using multicomponent fibers in which a component is dissolved away in the process, such as after a composite membrane is skived from a billet. As used herein, the term “multicomponent fiber” denotes fibers containing two or more components (e.g., bi-component, tri-component, and so on). The term “capillary array” as used herein denotes a membrane or sheet in which pores can be partially or completely filled with other species, such as a composite sheet used for making an IC membrane, according to example, for incorporation in lithium transport separator utilized in a Li—S cell or battery.

According to the principles of the inventions hereof, as demonstrated in the following examples and embodiments, there are Li—S cells incorporating ionomer-containing articles, such as a lithium transport separator comprising an IC membrane. An IC membrane contains at least one type of ionomer and one or more other materials, such as a second ionomer and/or a polymer that is not an ion-containing polymer, such as a polyolefin. The IC membrane may be associated with various elements in a Li—S cell, such as an IC membrane attached to and/or functioning as part, or all, of a lithium transport separator situated in an electrolyte medium of the cell. According to various embodiments, different types of ionomers may be used in forming an IC membrane.

According to an example, an ionomer may be halogen ionomer, such as a fluorinated ionomer containing sulfonate groups based on ionized sulfonic acid (e.g., fluorosulfonic acid (i.e., FSA) ionomer). According to another example, an ionomer may be a hydrocarbon ionomer containing (meth)acrylate groups based on ionized (meth)acrylic acid. In still another example, a combination of hydrocarbon ionomer(s) and halogen ionomer(s) may be incorporated in an IC membrane. The combination of ionomers may comprise separate constituent ionomers which are located in distinct parts of an IC membrane, such as in separate laterally isolated regions and/or separate laterally adjacent regions. In the alternative, a combination of ionomers may comprise a blend of constituent ionomers which may be incorporated together into one or more parts of an IC membrane.

Examples of halogen ionomers which may be incorporated into an IC membrane include Nafion® (i.e., “NAFION”) and its derivatives. NAFION is a sulfonate-containing tetrafluoroethylene based fluoro-copolymer with fluorine located along the polymer backbone and branching. Other examples of halogen ionomers are perfluorocarboxylate ionomers, such as Flemion®, which contains both sulfonate and carboxylate groups. Fluorinated sulfonated halogen ionomers may be prepared using fluorinated vinyl monomers. Additional examples of halogen ionomers which may be incorporated in an IC membrane include sulfonated polyacrylamides, polyacrylates, polymethacrylates and sulfonated polystyrene which contain halogen. Other halogen ionomers may also be incorporated as well, or in the alternative, such as ionomers containing halogen and having ionomer functional groups based on neutralized carboxylic acids, phosphonic acids, phosphoric acids and/or other ionomer functional groups. The halogen ionomers always contain one or more halogen atoms, such as in halogen substituents and in halogen-containing substituents. The substituents may contain any species of halogen, such as fluorine as in a FSA ionomer, bromine as in a brominated polyurethane ionomer or another halogen species. The halogen atoms in a halogen ionomer may be located anywhere in the ionomer, such as along the backbone and/or along any branching which may be present.

Examples of hydrocarbon ionomers which may be incorporated into an IC membrane include Surlyn® (i.e., “SURLYN”) and derivatives of SURLYN, a copolymer of ethylene and (meth)acrylic acid. Depending upon the commercially available grade of SURLYN that is used, an amount of the ionizable (meth)acrylic acid groups in the SURLYN can be neutralized to their ionic (meth)acrylate salt. Other examples of hydrocarbon ionomers which may be incorporated in an IC membrane include sulfonated polyacrylamide and sulfonated polystyrene. Other hydrocarbon ionomers may be incorporated as well or in the alternative, such as ionomers having ionomer functional groups based on neutralized carboxylic acids, phosphonic acids, phosphoric acids and/or other ionomer functional groups.

Different types of copolymers may be incorporated as ionomers (e.g., halogen ionomers, hydrocarbon ionomers, etc.) in an IC membrane, such as copolymers with different non-ionic monomers or multiple types of ionic monomers. Other ionomers may be combined in an IC membrane, such as ionomers having the same or different ionic functionality, but with otherwise different polymeric structures and/or different non-ionic substituents. As an example, an ionomer may include both alcohol and alkyl substituents. In another example, an ionomer may include unsaturated branches with or without any functional groups or substituents. The substituent sites on a hydrocarbon ionomer may be located substantially anywhere in a polymer, such as along the backbone and/or along any branching which may be present.

One or more ionomers may be combined with other components to form an IC membrane which can be incorporated into a Li—S cell, according to various embodiments. The ionomers may be quantified in different ways with respect to other components present within the IC membrane. For example, an IC membrane may comprise a hydrocarbon ionomer, such as a SURLYN derivative, as one membrane material in laterally adjacent regions (LARs) of the IC membrane. The same IC membrane may have localized and/or laterally isolated regions (LIRs) comprising a halogen ionomer, such as a NAFION derivative. The NAFION derivative may be introduced into LIRs surrounded by one or more LARs comprising the SURLYN derivative by various processes, such as by a fibers-on-end (FOE) process and/or other processes, as described in greater detail below. An IC membrane may be further processed, such as by press-forming to produce an ionomer article, such as a lithium transport separator for a Li—S cell.

According to an embodiment, an IC membrane may be prepared using a fibers-on-end (FOE) process, such as is described in U.S. Pat. No. 7,965,049 entitled “Processes for making Fiber-On-End Materials” by Kapur et al., which is incorporated herein by reference in its entirety. The IC membrane incorporates at least one ionomeric material and may incorporate one or more other materials that may or may not be ionomeric. An ionomer may be incorporated into areas associated with pores of an intermediate-product film, composite or membrane used in forming a final-product IC membrane, such as a vacated composite sheet, according to an example. The areas associated with the pores in the intermediate-product correspond with the laterally isolated regions (LIRs) of the final-product IC membrane, which is formed upon incorporating the ionomer into the pores. According to an example, the regions surrounding the LIRs in the IC membrane are laterally adjacent regions (LARs) of the final-product IC membrane.

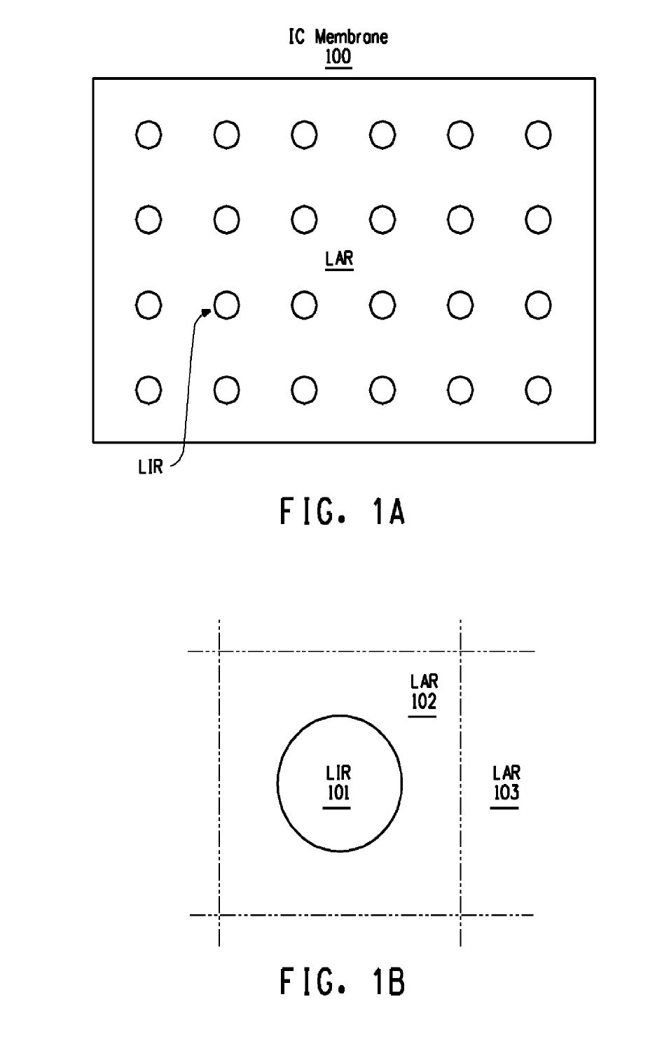

Referring to FIG. 1A, depicted is a schematic drawing of an IC membrane 100 with several laterally isolated regions (i.e., “LIRs”) distributed uniformly throughout the IC membrane containing one integrated LAR, such as in an “islands-in-the-sea” configuration. According to an example, the pores in a film or composite used in making IC membrane 100, corresponds with laterally isolated regions (LIRs) in the IC membrane. A laterally adjacent region (LAR) may generally include a polymer material which surrounds the center of a multicomponent fiber used for making an IC membrane, such as by an FOE process. FIG. 1A shows IC membrane 100 having one integrated LAR surrounding several LIRs, one of which is labeled in FIG. 1A. In FIG. 1A all the LIRs shown are completely surrounded by the single integrated LAR. In other embodiments, one or more LIRs may partially contact an edge of an IC membrane. In another embodiment, two LIRs comprising different materials may contact each other, in addition to contacting one or more LARs or an edge of IC membrane.

Referring to FIG. 1B, depicted is a schematic drawing of a single laterally isolated region (LIR) 101 of an IC membrane made by an FOE process. The polymer material in LIR 101 may or may not contain an ion-containing polymer, such as an ionomer. The LIR 101 is surrounded by a laterally adjacent region (LAR) 102. The polymer material in LAR 102 corresponds with the polymer material which surrounded the center of a multicomponent fiber which had been used for making the IC membrane including the LIR 101. The polymer material in LAR 102 may or may not be an ion containing polymer, such as an ionomer. Also depicted in FIG. 1B is a second laterally adjacent region, LAR 103, shown to the right of LAR 102. The polymer material in LAR 103 is the material which had surrounded the center of a second multicomponent fiber used in making the IC membrane containing LIR 101. The polymer material in LAR 103 may or may not be an ion-containing polymer.

In making the IC membrane of FIG. 1B, according to an FOE process, the respective materials in LAR 102 and LAR 103 can be the same type of polymer material. In this case, the materials in LAR 102 and LAR 103 can merge in the FOE process to form a single laterally adjacent region LAR in the IC membrane 100. In another example, the polymer materials in LAR 102 and LAR 103 may be different and these laterally adjacent regions would not merge. Instead LAR102 and LAR 103 could represent separate and distinct laterally adjacent regions in the IC membrane. Similarly, the LIR 101 shown in FIG. 1B is depicted as circular. However, alternative shapes such as ellipses, squares and other polygonal shapes may also form LIRs in an IC membrane.

According to an example, an IC membrane may incorporate different types of ionomer into different types of regions of an IC membrane, such as an IC membrane with a NAFION derivative incorporated into one or more LIRs and a SURLYN derivative incorporated into one or more LARs. In another example, the location of these ionomers may be reversed, and/or different materials may be utilized which may or may not comprise ion-containing polymers. Other configurations are also possible, such as an IC membrane incorporating a blend of ionomers or a sequential layer of different ionomers in one or more locations of the IC membrane.

Furthermore, polymeric materials which are not ion-containing may be used for making part of an IC membrane. Examples of classes of suitable polymer materials include, but are not limited to, homopolymers, copolymers and blends of: polyolefins, polyesters, polyamides, polyurethanes, polyethers, polysulfones, vinyl polymers, polystyrenes, polysilanes, fluorinated polymers and variants thereof as described in U.S. Pat. No. 7,965,049 to Kapur et al., which is incorporated by reference above.

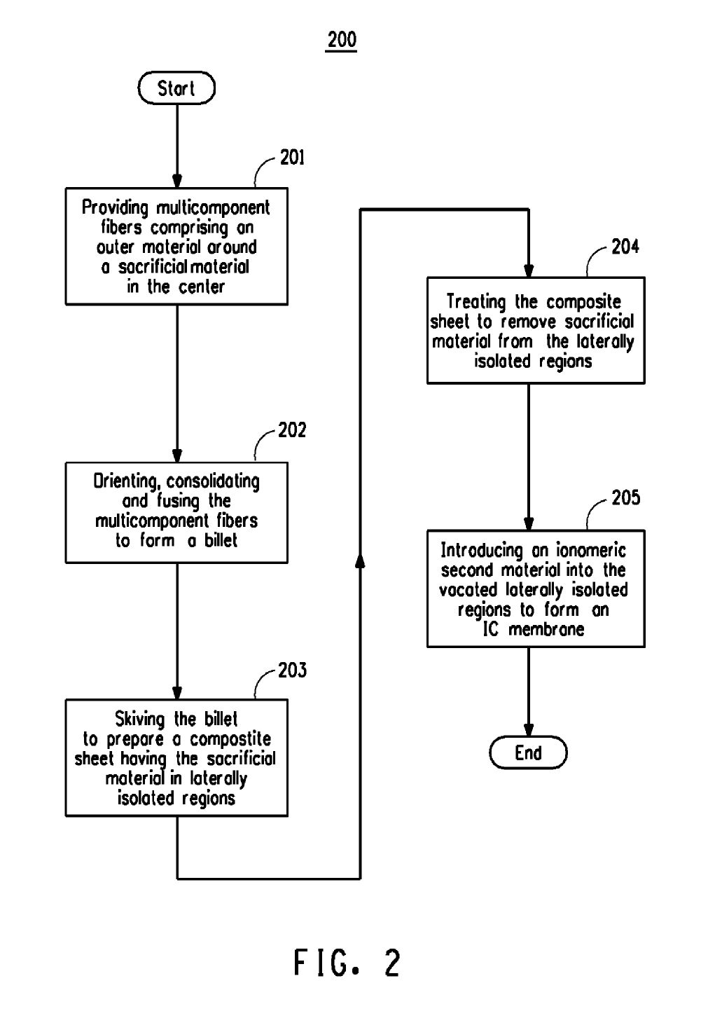

Referring to FIG. 2, depicted is a flow diagram 200 showing steps in a FOE process for preparing an IC membrane, according to an example. The IC membrane comprises laterally adjacent regions (LARs) containing a SURLYN derivative ionomer and laterally isolated regions (LIRs) containing a NAFION derivative ionomer. The IC membrane may be utilized in or as a lithium transport separator in a Li—S cell or battery.

In Step 201, multicomponent fibers are provided comprising a SURLYN outer material encircling a center containing a sacrificial material which is a soluble polymer. Multicomponent fibers suitable for use can be made by various methods known in the art for making multicomponent fibers. Depending on the particular polymer(s) used, fibers can be spun from solution (for example, polyureas, polyurethanes) or from a melt (for example, polyolefin, polyamide, polyester). Sheath-core construction methods may also be utilized to produce multicomponent fibers. Materials, equipment, principles, and processes concerning the production of fibers are discussed in detail in Fourne, F., Synthetic Fibers, (Carl Hanser Verlag, 1999), translated and edited by H. H. A. Hergeth and R. Mears.

Fibers are well known; their manufacture and applications are discussed in, for example, Fourne, and by Irving Moch, Jr. in “Hollow Fiber Membranes,” Kirk-Othmer Encyclopedia of Chemical Technology, 4th edition, volume 13, pages 312-337 (John Wiley & Sons, 1996). The production of bi- and multicomponent fibers (for example, “islands in the sea” and “sheath-core” fibers) is discussed in, for example, Fourne, pp. 539-548 and 717-720. The term “islands in the sea” as used herein denotes a type of bicomponent or multicomponent fiber which may also be described as “multiple interface” or “filament-in-matrix”. The “islands” are cores or fibrils of finite length, and comprise one or more polymers imbedded in a “sea” (or matrix) consisting of another polymer. The matrix may be dissolved away to leave filaments of very low denier per filament. Conversely, the islands may be dissolved away to leave a hollow fiber. The term “sheath-core” as used herein denotes a bi- or multicomponent fiber of two polymer types or two or more variants of the same polymer. In a bi-component sheath-core fiber, one polymer forms a core and the other surrounds it as a sheath. Multicomponent sheath-core type fibers or two or more polymers can also be made, containing a core, one or more inner sheaths, and an outer sheath.

A broad range of sacrificial materials may be utilized to fill the hollow of the SURLYN filament. Suitable sacrificial materials include polyamides which may be solubilized in formic acid, polyurethanes which may be solubilized in a polar solvent and polystyrenes which may be solubilized in an aromatic solvent. Other sacrificial materials suitable for use are described in U.S. Pat. No. 7,964,049 to Kapur et al., incorporated by reference above, and in U.S. Patent Application Publication Nos. U.S. 2008/0023015 and U.S. 2008/0023125, both entitled “Processes for Making Fiber-On-End Materials”, both to Arnold el al. and both of which are incorporated herein by reference in their entireties.

In Step 202, the multicomponent fibers incorporating SURLYN around a central sacrificial material are oriented, consolidated and fused together to form a billet. The billet is a relatively defect free block of multicomponent fibers which are fused and thus bound together. The fusing to bind the multicomponent fibers together may be accomplished using various means. Although thermal fusing is generally preferred, other means may be used such as by using a binder or solvent bonding to fuse the fibers together. The binder or solvent bonding means for fusing the multicomponent fibers may be utilized in the alternative or in conjunction with thermal fusing to form the billet.

In Step 203, the formed billet is skived to form a composite sheet having a desired thickness. The skiving may be performed at an angle perpendicular to the orientation of the fibers in the billet to prepare the skived composite sheet. Skiving may also be performed at other angles. After heat fusion of the fibers forming the billet and then skiving the composite sheet from the billet. The skived composite sheet comprises the SURLYN derivative in a single integrated laterally adjacent region (LAR) in the composite sheet. The SURLYN derivative in the integrated LAR had made up the outer or “tubular” component surrounding the sacrificial material of the constituent multicomponent fibers. However, when the multicomponent fibers were fused together to form the billet in step 202, the SURLYN derivative in the respective multicomponent fibers was joined together through the fusing and merged to form the integrated LAR of the IC membrane. In alternative embodiments a skived composite sheet may comprise one or more LARs containing an ionomer other than the SURLYN derivative. A non-ionomeric material may also be used.

According to the example, in Step 204, the skived composite sheet is post-treated to remove at least part, and preferably all of the sacrificial material. The sacrificial material can be replaced with a NAFION derivative in the vacated LIRs to form an IC membrane with both types of ionomer. The sacrificial material is solubilized by using an appropriate solvent for the particular sacrificial material utilized in the multicomponent fibers. Other well-known vehicles may also be applied for solubilizing the sacrificial material while retaining the SURLYN derivative. Such vehicles include heat, agitation, washing, etc.

After the sacrificial material is removed, in Step 205, the NAFION derivative is introduced into the emptied pores of the skived composite sheet, such as by capillary action, to form an IC membrane. The full length of the pores in the IC membrane need not be completely filled throughout out their entire volumes with the NAFION derivative. However, it is preferable for an IC membrane which is to be utilized as a separator in a Li—S cell that the emptied pores be at least partially filled, without any voids left that extend through the full length of the pores traversing the IC membrane. The filled pores of the skived composite sheet correspond with LIRs, incorporating NAFION derivative, in the formed IC membrane. In related examples, one or more of the LIRs and/or LARs of an IC membrane may incorporate other materials such as other ionomers and/or non-ionomeric substances.

IC membranes made by an FOE process are often preferred due to the control afforded in specifying precise structural parameters of a formed IC membrane. The structural parameters include the external dimensions of the membrane, such as the membrane thickness, and other parameters, such as the average pore diameter, the membrane porosity, the percentage of membrane porosity filled with an introduced material, the pore distribution in the membrane and the like. The structure of an IC membrane made by an FOE process demonstrates structural precision, such as by the structure having pores which extend through the IC membrane and are highly uniform in their shape, size and orientation.

The pore structure may be controlled through the earlier stages of the FOE process associated with orienting and consolidating multicomponent fibers prior to fusing them to form a billet, such as described above in Step 201 of FIG. 2. Furthermore, the distribution of such pores in an IC membrane may be precisely controlled through the FOE process, such as by placing certain types of alternative fibers among the multicomponent fibers when they are oriented to form a billet as described above in Step 202 of FIG. 2. Without being bound by any particular theory, it is believed that the improved control over the precision of the structural parameters of the IC membranes, such as when made using an FOE process, appears to contribute to the surprising and unexpectedly high coulombic efficiency and low capacity degradation when the IC membranes are incorporated into lithium transport separators utilized in Li—S cells, especially compared with conventional separators or separators without ionomeric components.

IC membranes suitable for use herein may be described in terms of the thickness of the membranes. The term “thickness” as used herein is synonymous; generally, with the average thickness of a membrane unless otherwise indicated by the context in which it is used. IC membranes suitable for use herein include those having a thickness of about 3 to 500 microns (i.e., μm). IC membranes having a suitable thickness include those having a thickness of about 3 μm, 5 μm, 10 μm, 20 μm, 40 μm, 60 μm, 80 μm, 100 μm, 150 μm, 200 μm, 250 μm, 300 μm, 400 μm, 500 μm and larger thicknesses. Considerations for larger thicknesses than 500 μm in an IC membrane include having pores which are sufficiently large so as to be vacated of any sacrificial material, if needed, in a process of making the IC membrane, such as by an FOE process.

IC membranes suitable for use herein may also be described in terms of the porosity of the membranes. An IC membrane may be made based on a film or membrane having pores which are associated with laterally isolated regions (LIRs) in the IC membrane. The porosity of the film or membrane may be associated with pores which are uniformly distributed, distributed at random, or distributed according to a pattern. In addition, the pores of the film or membrane may be distributed over part or all of the surface areas of the film or membrane used to form an IC membrane. In general, the porosity of an IC membrane is associated with those surface areas of the film or membrane which have pores. IC membranes having a suitable porosity include those having a porosity of about 0.1%, 0.5%, 1%, 2%, 5%, 10%, 15%, 20%, 25%, 30%, 35%, 40%, 45%, 50%, 55%, 60%, 65%, 70%, 75%, 80% and higher porosities. Considerations for higher porosities in an IC membrane include the physical and chemical properties of the materials used in a process of making the IC membrane, such as by an FOE process.

IC membranes suitable for use herein may be described in terms of the pore diameter(s) of pores in a film, composite or membrane used in making the IC membrane. The pores are associated with the laterally isolated regions (LIRs) in the IC membrane. The pores may or may not be uniformly round, or uniformly the same size. Accordingly, the pores may be described as having an average dimension of an average pore diameter (i.e., an “average pore diameter dimension”). In an instance in which all the pores are substantially round and uniform in size, the average pore diameter dimension is equivalent to the pore diameter shared by all the pores. In an instance in which all the pores are substantially the same size, but may have different shapes, the average pore diameter dimension is equivalent to the average pore diameter. In addition, the pores associated with an IC membrane made by an FOE process may be uniformly shaped at the IC membrane surface, such as by being circular and with equivalent size diameters. In addition, the volume of such pores may be uniform as well, such as being uniformly cylindrical, having the same diameter dimension throughout the respective lengths of the cylinders in the pores. However, films or membranes with variations on one or more of these parameters may also be used.

IC membranes suitable for use herein include those having an average pore diameter dimension of about 0.1 to 150 microns (i.e., μm) associated with laterally isolated regions (LIRs) in the IC membrane. These include IC membranes having LIRs associated with an average pore diameter dimension of about 0.1 μm, 0.5 μm, 1 μm, 3 μm, 5 μm, 10 μm, 20 μm, 40 μm, 60 μm, 75 μm, 80 μm, 100 μm and 150 μm. Considerations for higher average pore diameter dimensions in an IC membrane include the physical and chemical properties of the materials used in a process of making the IC membrane, such as an FOE process.

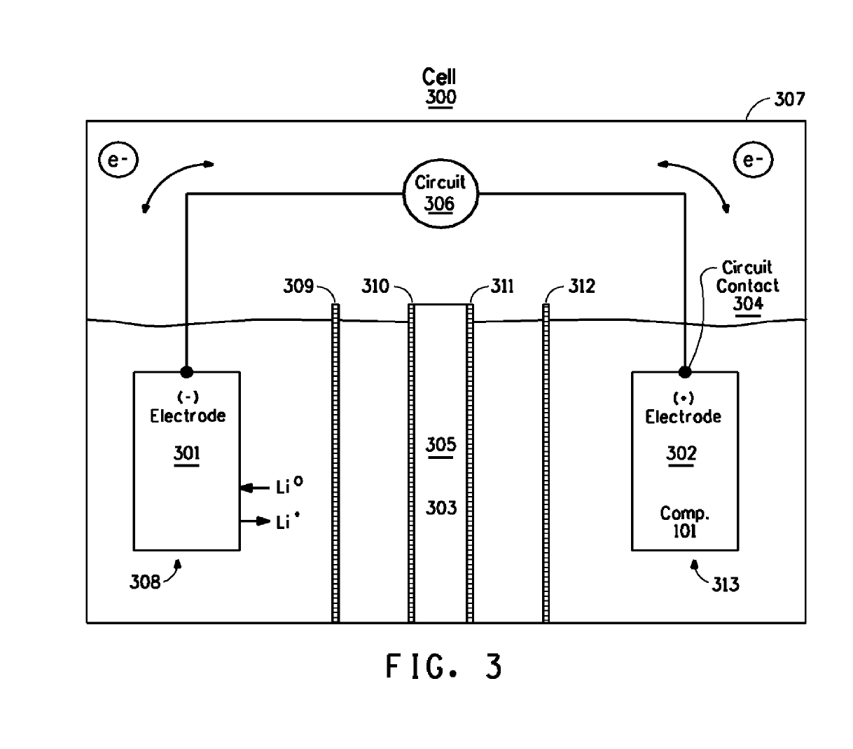

Referring to FIG. 3, depicted is a cell 300, such as a Li—S cell in a Li—S battery. Cell 300 includes a lithium containing negative electrode 301, a sulfur-containing positive electrode 302, a circuit 306 and a lithium transport separator 305. A cell container wall 307 contains the elements in the cell 300 with an electrolyte medium, such as a cell solution comprising solvent and electrolyte. The positive electrode 302 includes a circuit contact 304. The circuit contact 304 provides a conductive conduit through a metallic circuit 306 coupling the negative electrode 301 and the positive electrode 302. The positive electrode 302 is operable in conjunction with the negative electrode 301 to store electrochemical voltaic energy in the cell 300 and to release electrochemical voltaic energy from the cell 300, thus converting chemical and electrical energy from one form to the other, depending upon whether the cell 300 is in the charge phase or the discharge phase.

A porous carbon material, such as a carbon powder, having a high surface area and a high pore volume, may be utilized in the making the positive electrode 302. According to an embodiment, a sulfur compound, such as elemental sulfur, lithium sulfide, and combinations of such, may be introduced to the porous regions within the carbon powder to make a carbon-sulfur (C—S) composite which is incorporated into a cathode composition in the positive electrode 302. A polymeric binder may also be incorporated into the cathode composition with the C—S composite in the positive electrode 302. In addition, other materials may be utilized in the positive electrode 302 to host the sulfur compound as an alternative to the carbon powder, such as graphite, graphene and carbon fibers. The structure used to host the sulfur compound in the positive electrode 302 need not be a C—S composite, and the construction of the positive electrode 302 may be varied as desired.

The lithium transport separator 305 in cell 300 incorporates an IC membrane 303 comprising an ionomer, such as a NAFION derivative, in one or more laterally adjacent regions (LARs) and/or laterally isolated regions (LIRs) of the IC membrane 303. When situated in the cell 300, the IC membrane 303 within the lithium transport separator 305 may be exposed to an amount of cell solution. The exposed areas of the IC membrane 303 appear to function as a barrier to limit the passage of soluble sulfur compounds (e.g., lithium polysulfides) “shuttling” through the cell solution from reaching the negative electrode 301. However, the IC membrane 303 in the lithium transport separator 305 still permits the diffusion of lithium ions through at least the LIRs and/or LARs comprising the NAFION derivative during the charge and discharge phases of the cell 300. The IC membrane 303 may also function as a reservoir through adsorption of the lithium polysulfides from the cell solution which is exposed to the IC membrane 303, thus withdrawing these sulfur compounds temporarily from the cell solution.

In addition to IC membrane 303, cell 300 also includes IC membranes 308, 309, 310, 311, 312 and 313, all of which comprise at least one ionomer, such as a NAFION derivative, in at least one or more of their respective LIRs and/or LARs.

IC membrane 308 is an anodic-lithium transport separator as it is affixed or in close proximity to a surface of the negative electrode 301. IC membrane 308 comprises at least one ionomer, such as one of the halogen or hydrocarbon ionomers noted above. In an embodiment, IC membrane 308 includes a protective layer, separating lithium metal in the negative electrode 301 from the halogen ionomer in the IC membrane 308. The protective layer comprises a permeable substance which is substantially inert to lithium metal in the negative electrode 301. Suitable inert substances include porous films containing polypropylene and polyethylene.

According to an embodiment, the ionomer in IC membrane 308 is a derivative of NAFION in which the NAFION is partially neutralized with a lithium ion source. In other embodiments, IC membrane 308 may comprise another ionomer, as an alternative, or in addition to the NAFION derivative in the anodic-membrane, IC membrane 308. The IC membrane 308 is permeable to lithium ions, but functions in the cell 300 as a barrier to limit the passage of soluble sulfur compounds shuttling in the cell solution from reaching the negative electrode 301. IC membrane 308 may also function as a reservoir through adsorption of soluble sulfur compounds from the cell solution or by otherwise limiting their passage through the IC membrane 308. However, IC membrane 308 permits diffusion of lithium ions to and from the negative electrode 301 during charge or discharge phases in the cell 300.

IC membranes 309 and 312 are lithium transport separators which are fully situated within the cell solution of the cell 300. IC membranes 310 and 311 are lithium transport separators which are situated so one face covers a respective side of the lithium transport separator 305 while an opposing face is exposed to the cell solution of the cell 300. All the IC membranes 309-312 are located between positive electrode 302 and the negative electrode 301, but are located on one side or the other of the lithium transport separator 305 and may be secured within cell 300 by being affixed to another object in the cell 300, such as the cell container wall 307.

IC membrane 313 is a cathodic-lithium transport separator which is affixed or in close proximity to a surface of the positive electrode 302. IC membrane 313 is similar to the IC membrane 308 near the electrode 301 and comprises at least some ionomer, such as a halogen ionomer which may be incorporated as in membrane 308. IC membrane 313 is in proximity with the positive electrode 302 which has no highly reactive lithium metal surfaces, so IC membrane 313 generally does not include a protective layer as the IC membrane 308 near negative electrode 301, according to an embodiment.

All the IC membranes 309-313 may, or may not, share the same or similar membrane structural parameters and/or membrane morphologies. However, they all comprise at least some amount of at least one type of ionomer, such as halogen ionomer. Given any differences in their respective membrane structures and their respective membrane morphologies, they otherwise function similarly in the cell 300 as lithium transport separators, such as described above with respect to IC membranes 308 and 303.

According to the principles of the invention, a Li—S cell, such as cell 300, incorporates at least one IC membrane and may incorporate a plurality of IC membranes as demonstrated in cell 300, and in various different combinations and configurations. In one embodiment, an IC membrane may comprise an ionomer that is a polymeric sulfonate. In another embodiment, an IC membrane may comprise an ionomer that is a polymeric carboxylate. In yet another embodiment, an IC membrane may comprise an ionomer that is a polymeric phosphate or a polymeric phosphonate. In still another embodiment, an IC membrane may comprise an ionomer that is a copolymer including at least two types of ionic functionality. In still yet another embodiment, an IC membrane may comprise at least two different types of ionomer with different ionic functionality in the same ionomer and/or in distinct ionomers.

An amount of ionomer in an IC membrane may be quantified in terms of an amount of ionomer associated with a volume of material within the IC membrane, or below an area on the surface of the IC membrane. Such an area is associated with comprising the ionomer contained below it (i.e., an ionomer-containing area), such as a laterally isolated area (LIR) and/or a laterally adjacent area (LAR). According to an embodiment, a suitable amount of ionomer in an ionomer-containing LIR or LAR is about 0.0001 to 100 mg/cm². In other embodiments, a suitable amount of ionomer in an ionomer-containing LIR or LAR is about 0.001 to 75 mg/cm², about 0.001 to 50 mg/cm², about 0.001 to 35 mg/cm², about 0.01 to 20 mg/cm², about 0.01 to 15 mg/cm², about 0.1 to 10 mg/cm² and about 0.3 to 5 mg/cm².

An amount of ionomer in an IC membrane may be expressed as a weight percentage of ionomer present in an ionomer-containing LIR or LAR of an IC membrane. The ionomer loading in an ionomer-containing LIR or LAR of an IC membrane may be varied as desired. According to an embodiment, a suitable amount of ionomer in an ionomer-containing LIR or LAR of an IC membrane is about 0.0001 to 100 wt. %. According to other embodiments, a suitable amount of ionomer in an ionomer-containing LIR or LAR of an IC membrane is about 0.0001 wt. % to about 99 wt. %, 98 wt. %, 95 wt. %, 90 wt. %, 85 wt. %, 80 wt. %, 75 wt. %, 70 wt. %, 65 wt. %, 60 wt. %, 55 wt. %, 50 wt. %, 45 wt. %, 40 wt. %, 35 wt. %, 30 wt. %, 25 wt. %, 20 wt. %, 15 wt. %, 10 wt. %, 5 wt. %, 2 wt. %, 1 wt. %, 0.1 wt. %, 0.01 wt. % and 0.001 wt. %.

In an embodiment, an IC membrane may modify another element in a cell, such as a lithium transport separator in a porous separator in an electrolyte medium of the cell. In another embodiment, an IC membrane may form a separate element in a cell, which is situated in the cell solution, separate from other elements in the cell. Such an IC membrane may float freely in the cell solution or be secured, such as by being affixed to a cell wall. In this circumstance, the IC membrane may be fully or partially situated within the electrolyte medium and may be secured by fastening an edge of the IC membrane to the interior wall of the cell, or by affixing it to another element or part in the cell.

Ionomers suitable for use herein, include ionomers which incorporate pendant negatively charged functional groups which are neutralized. The negatively charged functional groups may be an acid (e.g., carboxylic acid, phosphonic acid and sulfonic acid) or an amide (e.g., acrylamide). The negatively charged functional groups may be neutralized, fully or partially with a metal ion, preferably with an alkali metal which may be ion-exchanged into the ionomer. Lithium is preferred for an ionomer utilized within an IC membrane in a Li—S cell. An ionomer may contain negatively-charged functional groups, exclusively (i.e., anionomers) or may contain a combination of negatively-charged functional groups with some positively-charged functional groups (i.e., ampholytes).

The ionomers may include ionic monomer units copolymerized with nonionic (i.e., electrically neutral) monomer units. The ionic functional groups may be randomly distributed or regularly located in the ionomers. The ionomers can be prepared by polymerization of ionic monomers, such as ethylenically unsaturated carboxylic acid comonomers. Other ionomers suitable for use herein are ionically modified “ionogenic” polymers which may be made by chemical modification of negatively charged functional groups on the ionogenic polymer (i.e., chemical modification after polymerization). These may be made, such as by treatment of a polymer having carboxylic acid functionality which is chemically modified by neutralizing to form ester-containing carboxylate functional groups. The ester-containing carboxylate functional groups are ionized with an alkali metal, thus forming negatively charged ionic functionality.

Ionomers may be polymers including ionic and non-ionic monomeric units in a saturated or unsaturated backbone, optionally including branching, such as carbon-based branching and may include other elements, such as oxygen or silicon. The negatively charged functional groups may be any species capable of forming an ion with an alkali metal. These include, but are not limited to, sulfonic acids, carboxylic acids and phosphonic acids. According to an embodiment, the polymer backbone or branches in an ionomer may include comonomers such as alkyls. Alkyls which are α-olefins are preferred. Suitable α-olefin comonomers include, but are not limited to, ethylene, propylene, 1-butene, 1-pentene, 1-hexene, 1-heptene, 3 methyl-1-butene, 4-methyl-1-pentene, styrene and the like and mixtures of two or more of these α-olefins.

According to an embodiment, an ionomer may be an ionogenic acid copolymer which is neutralized with a base so that the acid groups in the precursor acid copolymer form ester salts, such as carboxylate or sulfonate groups. The precursor acid copolymer groups may be fully neutralized or partially neutralized to a “neutralization ratio” based on the amount neutralized of all the negatively charged functional groups that may be neutralized in the ionomer. According to an embodiment, the neutralization ratio is 0% to about 1%. In other embodiments, the neutralization ratio is about 5%, about 10%, about 20%, about 30%, about 40%, about 50%, about 60%, about 70%, about 80%, about 90%, about 95%, or about 100%. According to an embodiment, the neutralization ratio is about 0% to 90%. In other embodiments, the neutralization ratio is about 20% to 80%, about 30% to 70%, about 40% to 60% or about 50%.

The neutralization ratio may be selected for different desired properties, such as to promote conductivity in the ionomer, to promote the dispersability of the ionomer in a particular solvent or to promote miscibility with another polymer in a blend. Methods of changing the neutralization ratio include increasing the neutralization, such as by introducing basic ion sources to promote a greater degree of ionization among the monomer units. Methods of changing the neutralization ratio also include those for decreasing neutralization, such as by introducing a highly neutralized ionomer to strong acids to convert some or all of an ionic functionality (e.g., (meth)acrylate) to an acid (e.g., (meth)acrylic acid).

Although any stable cation is believed to be suitable as a counter-ion to the negatively charged functional groups in an ionomer, monovalent cations, such as cations of alkali metals, are preferred. Still more preferably, a base, such as a lithium ion-containing base, is utilized to provide a lithiated ionomer wherein part or all of the precursor groups are replaced by lithium salts. To obtain such ionomers, the precursor polymers may be neutralized, by any conventional procedure, with one or more ion sources. Typical basic ion sources include sodium hydroxide, sodium carbonate, zinc oxide, zinc acetate, magnesium hydroxide, and lithium hydroxide. Other basic ion sources are well known. A lithium ion source is preferred.

Halogen ionomers suitable for use herein are available from various commercial sources or they can be prepared by synthesis using methods well-known in the art. According to an embodiment, particularly useful halogen ionomers include NAFION and variants of NAFION which are derivatives of commercially available forms of NAFION. One NAFION variant may be made by treating a commercially available NAFION with a strong acid to reduce the overall neutralization ratio and to promote its dispersability in aqueous solution. According to another variant, a NAFION is ion-exchanged to increase its lithium ion content.

NAFION is an example of an FSA halogen ionomer. An FSA ionomer is a halogen ionomer which is a “highly-fluorinated” sulfonic acid halogen ionomer. “Highly fluorinated” means that at least about 50% of the total number of halogen and hydrogen atoms in the polymer are replaced by fluorine atoms. In an embodiment, at least about 75% are fluorinated, in another embodiment at least about 90% are fluorinated. In yet another embodiment, the polymer is perfluorinated, which is fully fluorinated or near to fully fluorinated. A sulphonic acid ionomer includes monomer units including a “sulfonate functional group.” The term “sulfonate functional group” in this context refers either to sulfonic acid groups or salts of sulfonic acid groups, and in one embodiment is alkali metal or ammonium salts. The sulfonate functional group is represented by the formula —SO₃X where X is a cation, also known as a “counterion”. X may be H, Li, Na, K or an amine. In one embodiment, X is H, in which case the ionomer is said to be in the “acid form”. X may also be multivalent, as represented by such ions as Ca⁺⁺, and Al⁺⁺⁺. In the case of multivalent counter ions, represented generally as Mⁿ⁺, the number of sulfonate functional groups per counterion is generally equal to the valence “n”.

In an embodiment, the FSA halogen ionomers comprise a polymer backbone with recurring side chains attached to the backbone, the side chains carrying counterion exchange groups. FSA halogen ionomers include homopolymers or copolymers of two or more monomers. Copolymers are typically formed from a nonfunctional first monomer and a second monomer carrying the counterion exchange group or its acid precursor, (e.g., a sulfonyl fluoride group (—SO₂F)), which can be subsequently hydrolyzed to a sulfonate functional group. For example, copolymers of a first fluorinated vinyl monomer copolymerized with a second fluorinated vinyl monomer having a sulfonyl fluoride group (—SO₂F) may be used. Possible first monomers include tetrafluoroethylene (TFE), hexafluoropropylene, vinyl fluoride, vinylidine fluoride, trifluoroethylene, chlorotrifluoroethylene, perfluoro(alkyl vinyl ether), and combinations thereof. TFE is preferred.

In another embodiment, at least one monomer may comprise fluorinated vinyl ether and a sulfonate functional group or precursor group which can provide a desired side chain in the FSA ionomer. Additional monomers, including ethylene, propylene, and R′—CH═CH₂ where R′ is a perfluorinated alkyl group of 1 to 10 carbon atoms, can be incorporated into the FSA halogen ionomer as desired. The FSA halogen ionomer may be of the type referred to as random copolymers. Random copolymers may be made by a polymerization process in which the relative concentrations of the comonomers are kept as constant as desired, so that the distribution of the monomer units along the polymer chain is in accordance with their relative concentrations and relative reactivities. Less random copolymers, such as those made by varying relative concentrations of monomers in the course of the polymerization, may also be used. Polymers of the type called block copolymers, may also be used.

In another embodiment, the FSA halogen ionomers suitable for use herein include a highly fluorinated backbone, including those that are a perfluorinated carbon backbone and side chains represented by the formula —(O—CF₂CFR_{f})ₐ—O—CF₂CFR′_{f}SO₃X in which R_{f} and R′_{f} are independently selected from F, Cl or a perfluorinated alkyl group having 1 to 10 carbon atoms, a being 0, 1 or 2, and X is H, Li, Na, K or an amine that may be the same or different. In one embodiment X is H, CH₃ or C₂H₅. In another embodiment X is H. As stated above, X may also be multivalent.

Useful FSA halogen ionomers include, for example, those disclosed in U.S. Pat. No. 3,282,875 and in U.S. Pat. Nos. 4,358,545 and 4,940,525 which are incorporated by reference herein in there entireties. An example of a preferred FSA halogen ionomer is one including a perfluorocarbon backbone and a side chain represented by the formula —O—CF₂CF(CF₃)—O—CF₂CF₂SO₃X where X is as described above. FSA halogen ionomers of this type are disclosed in U.S. Pat. No. 3,282,875 and can be made by copolymerization of tetrafluoroethylene (TFE) and the perfluorinated vinyl ether CF2=CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups. These may be ion exchanged as necessary to convert them to the desired ionic form. An example of a useful FSA halogen ionomer of this type is disclosed in U.S. Pat. Nos. 4,358,545 and 4,940,525 and has the side chain —O—CF₂CF₂SO₃X, wherein X is as described above. This FSA halogen ionomer can be made by copolymerization of tetrafluoroethylene (TFE) and the perfluorinated vinyl ether CF₂═CF—O—CF₂CF₂SO₂F, perfluoro(3-oxa4-pentenesulfonyl fluoride) (POPF), followed by hydrolysis and further ion exchange as necessary.

FSA halogen ionomers which are suitable for use herein generally have an ion exchange ratio of less than about 90, preferably less than 50, and even more preferably less than 33. As used herein, “ion exchange ratio” or “IXR” is defined as number of carbon atoms in the polymer backbone in relation to the counterion exchange groups. Within the range of less than about 33, IXR can be varied as desired. With most FSA halogen ionomers, the IXR is about 3 to about 33, and in another embodiment is about 8 to about 23.

The counterion exchange capacity of a polymer is often expressed in terms of equivalent weight (EW). For the purposes of its use herein, equivalent weight (EW) is the weight of the polymer in acid form required to neutralize one equivalent of sodium hydroxide. In the case of a sulfonate polymer where the polymer has a perfluorocarbon backbone and the side chain is —O—CF₂—CF(CF₃)—O—CF₂CF₂—SO₃H (or a salt thereof), the equivalent weight range which corresponds to an IXR of about 8 to about 23 is about 750 EW to about 1500 EW. IXR for this polymer can be related to equivalent weight using the formula: 50 IXR+344=EW. While the same IXR range is used for sulfonate polymers disclosed in U.S. Pat. Nos. 4,358,545 and 4,940,525, such as the FSA ionomer having the side chain —O—CF₂—CF(CF₃)—O—CF₂CF₂—SO₃H (or a salt thereof), the equivalent weight is somewhat lower because of the lower molecular weight of the monomer unit containing a counterion exchange group. For the IXR range of about 8 to about 23, the corresponding equivalent weight range is about 575 EW to about 1325 EW. IXR for this FSA ionomer can be related to equivalent weight using the formula: 50 IXR+178=EW.

The synthesis of FSA halogen ionomers is well known. The FSA halogen ionomers can be prepared as colloidal aqueous dispersions. They may also be in the form of dispersions in other media, examples of which include, but are not limited to, alcohol, water-soluble ethers, such as tetrahydrofuran, mixtures of water-soluble ethers, and combinations thereof. U.S. Pat. Nos. 4,433,082 and 6,150,426 disclose methods for making of aqueous alcoholic dispersions. After the dispersion is made, the concentration and the dispersing liquid composition can be adjusted by methods known in the art. Aqueous dispersions of FSA halogen ionomer are available commercially as NAFION dispersions, from E. I. du Pont de Nemours and Company and Sigma-Aldrich.

SURLYN is an example of a hydrocarbon ionomer which is a random copolymer-poly(ethylene-co-(meth)acrylic acid). E.I. du Pont de Nemours and Co., Wilmington, Del., provides the SURLYN resin brand, that generally incorporate a copolymer of ethylene and (meth)acrylic acid. SURLYN is produced through the copolymerization of ethylene and (meth)acrylic acid via a high pressure free radical reaction, similar to that for the production of low density polyethylene and has an incorporation ratio of (meth)acrylic comonomer that is relatively low and is typically less than 20% per mole and often less than 15% per mole of the copolymer. Variants of the SURLYN are disclosed in U.S. Pat. No. 6,518,365 which is incorporated by reference herein in its entirety. According to an embodiment, particularly useful hydrocarbon ionomers include SURLYN and variants of SURLYN which may be are derivatives of commercially available forms of SURLYN. One SURLYN derivative may be made by treating SURLYN with a strong acid to reduce the overall neutralization ratio to promote its dispersability in aqueous solution. According to another variant, SURLYN is ion-exchanged to increase the lithium ion content.

According to an embodiment, a suitable hydrocarbon ionomer includes ethylene-(meth)acrylic acid copolymer having about 5 to 25 wt. % (meth)acrylic acid monomer units based on the weight of the ethylene-(meth)acrylic acid copolymer; and more particularly, the ethylene-(meth)acrylic acid copolymer has a neutralization ratio of 0.40 to about 0.70. Hydrocarbon ionomers suitable for use herein are available from various commercial sources or they can be prepared by synthesis.

An ionomer, such as halogen and/or hydrocarbon ionomer, may be neutralized. Neutralization of the ionomer may be with a neutralization agent that may be represented by the formulas MA where M is a metal ion and A is the co-agent moiety such as an acid or base. Metal ions suitable as the metal ion include monovalent, divalent, trivalent and tetravalent metals. Metal ions suitable for use herein include, but are not limited to, ions of Groups IA, IB, HA, IIB, IIIA, IVA, IVB, VB, VIB, VIIB and VIII metals of the Periodic Table. Examples of such metals include Na⁺, Li⁺, K⁺ and Sn⁴⁺. Li⁺ is preferred for utilization of the ionomer in an IC membrane of a Li—S cell.

Neutralization agents suitable for use herein include any metal moiety which would be sufficiently basic to form a salt with a low molecular weight organic acid, such as benzoic acid or p-toluene sulfonic acid. One suitable neutralization agent is lithium hydroxide distributed by Sigma Aldrich (Sigma Aldrich, 545856). Other neutralization agents and neutralization processes to form ionomers are described in U.S. Pat. No. 5,003,012 which is incorporated by reference herein in its entirety.

Other ionomers which are suitable include block copolymers such as those derived from the sulphonation of polystyrene-b-polybutadiene-b-polystyrene. Sulfonated polysulphones and sulfonated polyether ether ketones are also suitable. Phosphonate ionomers may also be used, as well as copolymers with more than one ionic functionality. For example, direct co-polymerization of dibutyl vinylphosphonate with acrylic acid yields a mixed carboxylate-phosphonate ionomer. Copolymers derived from vinyl phosphonates with styrene, methyl methacrylate, and acrylamide may also be used. Phosphorus containing polymers can also be made after polymerization by phosphonylation reactions, typically with POCl₃. For example, phosphonylation of polyethylene can produce a polyethylene-phosphonic acid copolymer.

Ionomers which are suitable for use herein include carboxylate, sulfonate and phosphonate ionomers. Others are also suitable, such as styrene alkoxide ionomers such as those derived from polystyrene-co-4-methoxy styrene. An ionomer may have a polyvinyl or a polydiene backbone. Different ionomers may differ in properties, partly due to differences in the strength of the ionic interactions and structure. Carboxylate ionomers, sulfonate ionomers, and their mixtures are preferred. Also ionomers in which negatively charged ionic functional groups are neutralized with a lithium ion source to form a salt with lithium are preferred.

Referring again to FIG. 3, depicted is positive electrode 302 in cell 300. The positive electrode 302 may be made by incorporating a cathode composition comprising carbon-sulfur (C—S) composite made from sulfur compound and carbon powder. The cathode composition may also include a polymeric binder, a carbon black and optionally other materials.

A representative carbon powder for making the C—S composite is KETJENBLACK EC-600JD, distributed by Akzo Nobel having an approximate surface area of 1400 m²/g BET (Product Data Sheet for KETJENBLACK EC-600JD, Akzo Nobel) and an approximate pore volume of 4.07 cc/gram, as determined according to the BJH method, based on a cumulative pore volume for pores ranging from 17-3000 angstroms. In the BJH method, nitrogen adsorption/desorption measurements were performed on ASAP model 2400/2405 porosimeters (Micrometrics, Inc., No. 30093-1877). Samples were degassed at 150° C. overnight prior to data collection. Surface area measurements utilized a five-point adsorption isotherm collected over 0.05 to 0.20 p/p₀ and were analyzed via the BET method, described in Brunauer et al., J. Amer. Chem. Soc., v. 60, no. 309 (1938), and incorporated by reference herein in its entirety. Pore volume distributions utilized a 27 point desorption isotherm and were analyzed via the BJH method, described in Barret, et al., J. Amer. Chem. Soc., v. 73, no. 373 (1951), and incorporated by reference herein in its entirety.

Other commercially available carbon powders which may be utilized include KETJEN 300: approximate pore volume 1.08 cc/g (Akzo Nobel) CABOT BLACK PEARLS: approximate pore volume 2.55 cc/g, (Cabot), PRINTEX XE-2B: approximate pore volume 2.08 cc/g (Orion Carbon Blacks, The Cary Company). Other sources of such carbon powders are well-known to those of ordinary skill in the art.

Sulfur compounds which are suitable for making the C—S composite include molecular sulfur in its various allotropic forms and combinations thereof, such as “elemental sulfur.” Elemental sulfur is a common name for a combination of sulfur allotropes including puckered S₈ rings, and often including smaller puckered rings of sulfur. Other sulfur compounds which are suitable are compounds containing sulfur and one or more other elements. These include lithiated sulfur compounds, such as for example, Li₂S or Li₂S₂. A representative sulfur compound is elemental sulfur distributed by Sigma Aldrich as “Sulfur”, (Sigma Aldrich, 84683). Other sources of such sulfur compounds are known to those having ordinary skill in the art.

A polymeric binder which may be utilized for making the cathode composition includes polymers exhibiting chemical resistance, heat resistance as well as binding properties, such as polymers based on alkylenes, oxides and/or fluoropolymers. Examples of these polymers include polyethylene oxide (PEO), polyisobutylene (PIB), and polyvinylidene fluoride (PVDF). A representative polymeric binder is polyethylene oxide (PEO) with an average M_{w}, of 600,000 distributed by Sigma Aldrich as “Poly(ethylene oxide)”, (Sigma Aldrich, 182028). Another representative polymeric binder is polyisobutylene (PIB) with an average M_{w}, of 4,200,000 distributed by Sigma Aldrich as “Poly(isobutylene)”, (Sigma Aldrich, 181498). Polymeric binders which are suitable for use herein are also described in U.S. Published Patent Application No. US2010/0068622, which is incorporated by reference herein in its entirety. Other sources of polymeric binders are known to those having ordinary skill in the art.

Carbon blacks which are suitable for making the cathode composition include carbon substances exhibiting electrical conductivity and generally having a lower surface area and lower pore volume relative to the carbon powder described above. Carbon blacks typically are colloidal particles of elemental carbon produced through incomplete combustion or thermal decomposition of gaseous or liquid hydrocarbons under controlled conditions. Other conductive carbons which are also suitable are based on graphite. Suitable carbon blacks include acetylene carbon blacks which are preferred. A representative carbon black is SUPER C65 distributed by Timcal Ltd. and having BET nitrogen surface area of 62 m²/g carbon black measured by ASTM D3037-89. Other commercial sources of carbon black, and methods of manufacturing or synthesizing them, are known to those having ordinary skill in the art.

The C—S composite includes a porous carbon material, such as carbon powder, containing the sulfur compound situated in the carbon microstructure of the porous carbon material. The amount of sulfur compound which may be contained in the C—S composite (i.e., the sulfur loading in terms of the weight percentage of sulfur compound, based on the total weight of the C—S composite, is dependent to an extent on the pore volume of the carbon powder. Accordingly, as the pore volume of the carbon powder increases, higher sulfur loading with more sulfur compound is possible. Thus, a sulfur compound loading of, for example, about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 85 wt. %, 90 wt. % or 95 wt. % may be used. Ranges among these amounts define other embodiments which may be used.

The cathode composition may include various weight percentages of C—S composite. The cathode composition may optionally include polymeric binder and carbon black in addition to the C—S composite. The C—S composite is generally present in the cathode composition in an amount which is greater than 50 wt. % of the remainder of the cathode composition. Higher loading with more C—S composite is possible. Thus, a C—S composite loading of, for example, about 55 wt. %, 60 wt. %, 65 wt. %, 70 wt. %, 75 wt. %, 80 wt. %, 85 wt. %, 90 wt. %, 95 wt. %, 98 wt. %, or 99 wt. % may be used. According to an embodiment, about 50 to 99 wt. % C—S composite may be used. In another embodiment, about 70 to 95 wt. % C—S composite may be used. Ranges among these amounts describe other embodiments which may be used.

Polymeric binder may be present in the cathode composition in an amount which is greater than 1 wt. %. Higher loading with more polymeric binder is possible. Thus, a polymeric binder loading of, for example, about 2 wt. %, 3 wt. %, 4 wt. %, 5 wt. %, 6 wt. %, 7 wt. %, 8 wt. %, 9 wt. %, 10 wt. %, 12 wt. %, 14 wt. %, 16 wt. %, or 17.5 wt. % may be used. According to an embodiment, about 1 to 17.5 wt. % polymeric binder may be used. In another embodiment, about 1 to 12 wt. % polymeric binder may be used. In another embodiment, about 1 to 9 wt. % polymeric binder may be used. Ranges among these amounts describe other embodiments which may be used.

The C—S composite may made by various methods, including simply mixing, such as by dry grinding, the carbon powder with the sulfur compound. C—S composite may also be made by introducing the sulfur compound into the microstructure of the carbon powder utilizing such vehicles as heat, pressure, liquid (e.g., a dissolution of sulfur compound in carbon disulfide and impregnation by contacting the solution with the carbon powder), etc.

Useful methods for introducing sulfur compound into the carbon powder include melt imbibement and vapor imbibement. These are compositing processes. Other processes may be used for introducing the sulfur compound into the microstructure of the carbon powder utilizing such vehicles as heat, pressure, liquid, etc.

In melt imbibement, a sulfur compound, such as elemental sulfur can be heated above its melting point (about 113° C.) while in contact with the carbon powder to impregnate it. The impregnation may be accomplished through a direct process, such as a melt imbibement of elemental sulfur, at a raised temperature, by contacting the sulfur compound and carbon at a temperature above 100° C., such as 160° C. A useful temperature range is 120° C. to 170° C.

Another imbibement process which may be used for making the C—S composite is a vapor imbibement which involves the deposition of sulfur vapor. The sulfur compound may be raised to a temperature above 200° C., such as 300° C. At this temperature, the sulfur compound is vaporized and placed in proximity to, but not necessarily in direct contact with, the carbon powder.

These processes may be combined. For example, melt imbibement process can be followed by a higher temperature process. Alternatively, the sulfur compound can be dissolved in carbon disulfide to form a solution and the C—S composite can be formed by contacting this solution with the carbon powder. Sulfur compound may also be introduced to the carbon powder by other methods. For example, sodium sulfide (Na₂S) can be dissolved in an aqueous solution to form sodium polysulfide. The sodium polysulfide can be acidified to precipitate the sulfur compound in the carbon powder. In this process, the C—S composite may require thorough washing(s) to remove salt byproducts.

According to an embodiment, a C—S composite formed by a compositing process may be combined with polymeric binder and carbon black by conventional mixing or grinding processes. A solvent, preferably an organic solvent, such as toluene, alcohol, or n-methylpyrrolidone (NMP) may optionally be utilized. The solvent should preferably not react with the polymeric binder, if any. Conventional mixing and grinding processes are known to those having ordinary skill in the art. The ground or mixed components may form a composition, according to an embodiment, which may be processed and/or formed into an electrode.

Referring again to FIG. 3, depicted is the positive electrode 302, which may be formed to incorporate a cathode composition as described above. The formed positive electrode 302 may be utilized in the cell 300 in conjunction with a negative electrode, such as the lithium-containing negative electrode 301 described above. According to different embodiments, the negative electrode 301 may contain lithium metal or a lithium alloy. In another embodiment, the negative electrode 301 may contain graphite or some other non-lithium material. According to this embodiment, the positive electrode 302 is formed to include some form of lithium, such as lithium sulfide (Li₂S), and according to this embodiment, the C—S composite may be lithiated utilizing lithium sulfide which is incorporated into the powdered carbon to form the C—S composite, instead of elemental sulfur. A lithium transport separator, such as lithium transport separator 305, may be constructed from an IC membrane, such as the IC membrane 303 described above, or various other materials.

Positive electrode 302, negative electrode 301 and lithium transport separator 305 are in contact with a lithium-containing electrolyte medium in the cell 300, such as a cell solution with solvent and electrolyte. In this embodiment, the lithium-containing electrolyte medium is a liquid. In another embodiment, the lithium-containing electrolyte medium is a solid. In yet another embodiment, the lithium-containing electrolyte medium is a gel.

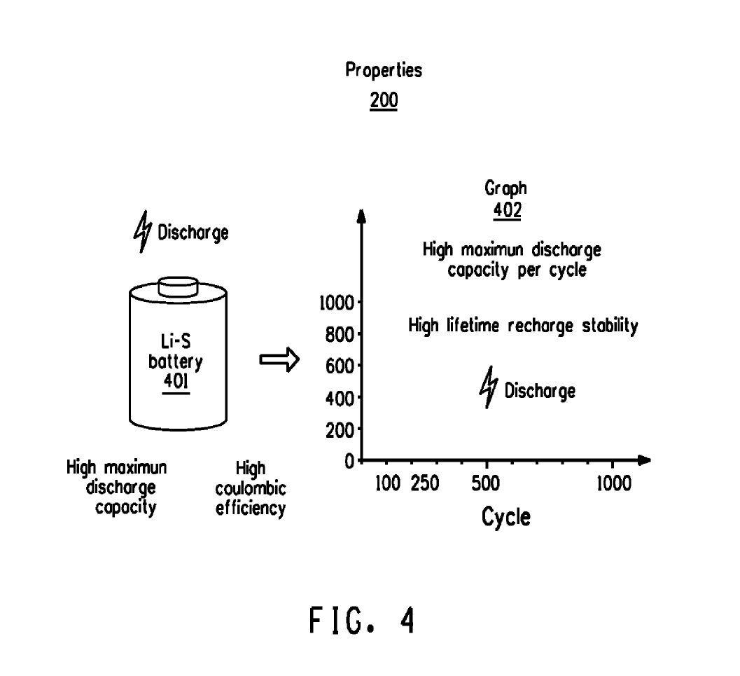

Referring to FIG. 4, depicted is a context diagram illustrating properties 400 of a Li—S battery 401 including a Li—S cell, such as the cell 300 described above, having a positive electrode including sulfur, such as positive electrode 302 and an IC membrane, such as IC membrane 303 in lithium transport separator 305. The Li—S cell in Li—S battery 401 incorporates one or more IC membranes, such as described above with respect to cell 300. The context diagram of FIG. 4 demonstrate the properties 400 of the Li—S battery 401. The properties 400 include high coulombic efficiency and high maximum discharge capacity associated with battery 401. The high coulombic efficiency appears to be directly attributable to the presence of the IC membrane(s) in the Li—S cell of Li—S battery 401. FIG. 4 also depicts graph 402. The graph 402 demonstrates the maximum discharge capacity per cycle of battery 401 with respect to a number of charge-discharge cycles. The battery 401 also exhibits high lifetime recharge stability and a high maximum discharge capacity per charge-discharge cycle. All these properties 400 of the Li—S battery 401 are demonstrated in greater detail below through the detailed examples.

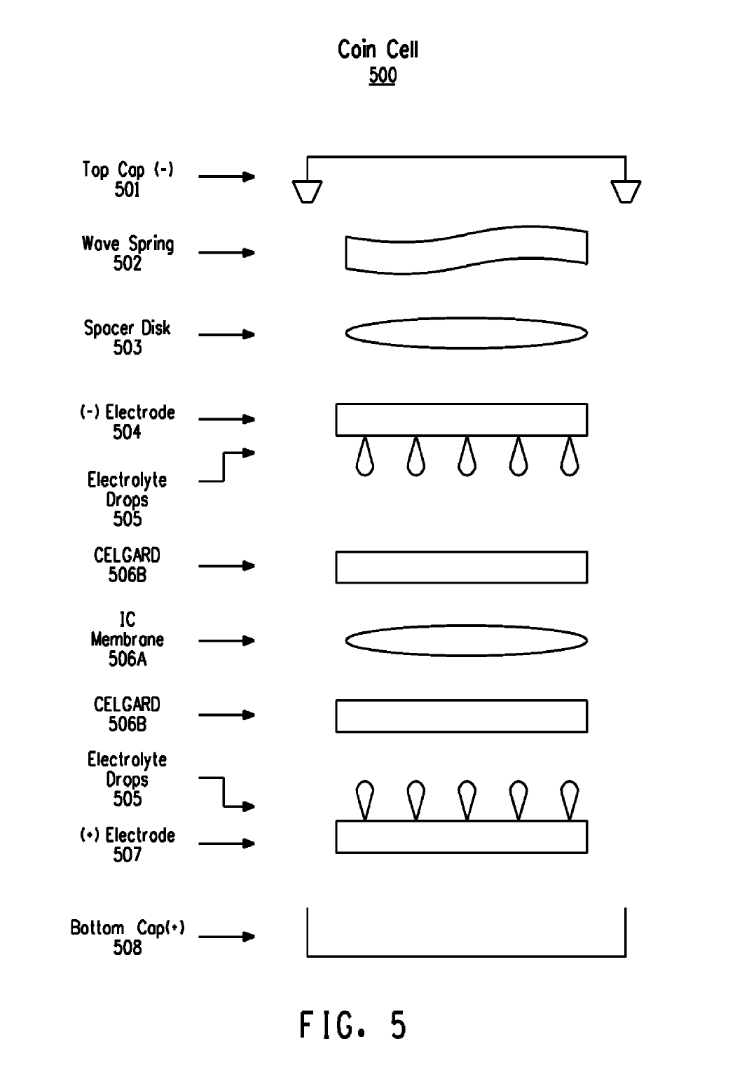

Referring to FIG. 5, depicted is a coin cell 500 which is operable as an electrochemical measuring device for testing various configurations and types of IC membranes. The function and structure of the coin cell 500 are analogous to those of the cell 300 depicted in FIG. 3. The coin cell 500, like the cell 300, utilizes a lithium-containing electrolyte medium. The lithium-containing electrolyte medium is in contact with the negative electrode and the positive electrode and may be a liquid containing solvent and lithium ion electrolyte.

The lithium ion electrolyte may be non-carbon-containing. For example, the lithium ion electrolyte may be a lithium salt of such counter ions as hexachlorophosphate (PF₆), perchlorate, chlorate, chlorite, perbromate, bromate, bromite, periodiate, iodate, aluminum fluorides (e.g., AlF₄), aluminum chlorides (e.g. Al₂Cl₇⁻, and AlCl₄⁻), aluminum bromides (e.g., AlBr₄), nitrate, nitrite, sulfate, sulfites, permanganate, ruthenate, perruthenate and the polyoxometallates.

In another embodiment, the lithium ion electrolyte may be carbon containing. For example, the lithium ion salt may contain organic counter ions such as carbonate, the carboxylates (e.g., formate, acetate, propionate, butyrate, valerate, lactacte, pyruvate, oxalate, malonate, glutarate, adipate, deconoate and the like), the sulfonates (e.g., CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as the fluorosulfonates (e.g., CF₃SO₃⁻, CF₃CF₂SO₃—, CF₃(CF₂)₂SO₃⁻, CHF₂CF₂SO₃⁻ and the like), the fluoroalkoxides (e.g., CF₃O—, CF₃CH₂O⁻, CF₃CF₂O⁻ and pentafluorophenolate), the fluoro carboxylates (e.g. trifluoroacetate and pentafluoropropionate) and fluorosulfonimides (e.g., (CF₃SO₂)₂N⁻). Other electrolytes which are suitable for use herein are disclosed in U.S. Published Patent Applications 2010/0035162 and 2011/00052998, both of which are incorporated herein by reference in their entireties.

The electrolyte medium may generally exclude a protic solvent, since protic liquids are generally reactive with the lithium anode. Solvents are preferable which may dissolve the electrolyte salt. For instance, the solvent may include an organic solvent such as polycarbonate, an ether or mixtures thereof. In other embodiments, the electrolyte medium may include a non-polar liquid. Some examples of non-polar liquids include the liquid hydrocarbons, such as pentane, hexane and the like.

Electrolyte preparations suitable for use in the cell solution may include one or more electrolyte salts in a nonaqueous electrolyte composition. Suitable electrolyte salts include without limitation: lithium hexafluorophosphate, Li PF₃(CF₂CF₃)₃, lithium bis(trifluoromethanesulfonyl)imide, lithium bis (perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris (trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts can also be used. In one embodiment, the electrolyte salt is lithium bis(trifluoromethanesulfonyl)imide). The electrolyte salt may be present in the nonaqueous electrolyte composition in an amount of about 0.2 to about 2.0 M, more particularly about 0.3 to about 1.5 M, and more particularly about 0.5 to about 1.2 M.

### EXAMPLES

### The following examples demonstrate the preparation of a vacated

composite sheet prepared by a process, such as shown in steps 1-4 of FIG. 2, the preparation of an IC membrane, such as shown in step 5 of FIG. 2, and the preparation of a Li—S coin cell, such as coin cell 500, containing the prepared IC membrane. A comparative example, demonstrating the preparation and testing of a coin cell without an IC membrane is also included. Reference is made to the specific examples below.

### Example 1

Example 1 demonstrates the preparation of a vacated composite sheet. The prepared vacated composite sheet has a SURLYN hydrocarbon ionomer the areas which correspond with laterally adjacent regions (LARs) in an IC membrane.

Preparation of Multicomponent Fibers:

Islands-in-the-sea multicomponent filaments were spun on a continuous filament spinning line using a spinneret configured for 61 islands and 144 filaments. The sea polymer was SURLYN 8150 resin (E. I. DuPont de Nemours and Company, Wilmington, Del.), which is an ethylene/methacrylic acid copolymer in which the methacrylic acid groups have been partially neutralized with sodium ions. The polymer for the islands was ZYTEL 7301 resin, a nylon 6 polymer also sold by DuPont, which was dried at 85° C. for 16 hours in a vacuum oven with a nitrogen purge. The SURLYN 8150 was dried at 60° C. for 16 hours.

The filaments were spun with a polymer ratio of 20% ZYTEL and 80% SURLYN at a spinning speed of 900 meters per minute at 0.25 grams of polymer per hole per minute providing a 334 denier yarn with 144 filaments of 2.32 dpf. Melt pump temperatures were set at 258° C. for the ZYTEL island polymer and 240° C. for the SURLYN sea polymer.

Orienting, Consolidating and Fusing the Multicomponent Fibers:

The yarns were subsequently back-wound onto cardboard tube cores using a modified winder in which the traverse speed was very slow relative to the winding speed. The modified winder was used in this way to permit the filaments to lay next to each other in a nearly parallel manner. The yarns were rewound in this manner until reaching a thickness of 1/16″. Five (5) rewound bobbins were then placed in a convection oven for 2 hours at 90° C. to fuse the filaments together. The fused filaments were then cut off of the bobbins and laid flat to create rectangular sheets. A manual die was then used to cut twelve (12) 2″×2″ squares from each sheet.

Fifty three (53) squares were then stacked inside a steel mold designed to fit the squares precisely, making sure to orient the direction of the filaments uniformly. A ram was then lowered into the mold on top of the squares. The mold was wrapped with an electric heater jacket and insulation. This assembly was then placed in a Carver press. The force on the ram was raised to 20,000 lbs. and held at that force throughout the following heating procedure.

The temperature was set initially to 55° C., the set point, and the block temperatures were measured to allow the block to reach the set point. The temperature was then held at 55° C. for 30 minutes, and then it was increased by 5° C. every 30 minutes until 84° C. was reached. The temperature was then increased by 2° C. every 30 minutes until 94° C. was reached and was held at 94° C. for 2 hours. The heater was then turned off and the block was allowed to cool down to room temperature. The 20,000 lbs. pressure was maintained on the cooled assembly overnight.

Skiving the Billet:

Upon removing the block from the mold, the finished billet was measured and had a height of 2.5″. It was then placed on a Leica SM2500E motorized sliding microtome with the fibers oriented vertically. The blade angle was set to 0 and composite sheets were skived each having a thickness of 50 microns.

Removing Sacrificial Material:

The composite sheets were then chemically etched to remove the nylon polymer islands by dipping in 3 successive 100% formic acid baths and then rinsing with demineralized water to form a vacated composite sheet. SEM images confirmed the resulting cylindrical pores to be approximately 1 micron in diameter. Porometry measurements made using a PMI model CFP 1200 AEXC indicated a mean flow pore diameter of approximately 0.7 microns.

### Example 2

Example 2 demonstrates the preparation and electrochemical evaluation of a Li—S cell incorporating an IC membrane made with halogen ionomer in the laterally isolated regions (LIRs) and hydrocarbon ionomer in laterally adjacent regions (LARs). The halogen ionomer is a lithium exchanged derivative of NAFION and the hydrocarbon ionomer is a sodium neutralized derivative of SURLYN.

Preparation of C—S Composite:

Approximately 1.0 cc of carbon powder (KETJENBLACK EC-600JD, Akzo Nobel, Amsterdam, Netherlands) having a surface area of approximately 1400 m2/g BET (Product Data Sheet for KETJENBLACK EC-600JD, Akzo Nobel) and a pore volume of 4.07 cc/g (as measured by the BJH method) was placed in a 30 ml glass vial and loaded into an autoclave which was charged with approximately 100 grams of elemental sulfur (Sigma Aldrich 84683, St. Louis, Mo.). The carbon powder was prevented from being in physical contact with the elemental sulfur but the carbon powder had access to sulfur vapor. The autoclave was closed, purged with nitrogen, and then heated to 350° C. for 24 hours under a static atmosphere to develop sulfur vapor. The final sulfur content of the C—S composite was 51.2 wt. % sulfur.

Jar Milling of C—S Composite:

1.72 g of the C—S composite described above, 48.7 g of toluene (EMD Chemicals, Darmstadt, Germany) and 110 g of 5 mm diameter zirconia media were weighed into a 125 mL polyethylene bottle. The bottle was sealed, and tumbled end-over-end inside a larger jar on jar mill for 15 hours.

Preparation of Electrode Composition (C—S Composite/Binder/Carbon Black Formulation):

Polyisobutylene (PIB) with average M_{w} of 4,200,000 (Sigma Aldrich 181498, St. Louis, Mo.) was dissolved in toluene to produce a 2.0 wt. % polymer solution. 137 mg of conductive carbon black SUPER C65 (Timcal Ltd., Bodio, Switzerland) (BET nitrogen surface area of 62 m²/g measured by ASTM D3037-89) (Technical Data Sheet for SUPER C65, Timcal Ltd.) was dispersed in 10.3 g of the 2.0 wt. % PIB solution, along with 10 g of toluene by mechanical stirring. 40.5 g of the jar milled suspension of C—S composite described above was added to the SUPER C65/PEB slurry along with 15 g of toluene. This ink formulation with about 2 wt. % solid loading was mixed by stirring for 3 hours.

Spray Coating to Form Layering/Electrode:

A layering/electrode was formed by spraying the ink formulation onto one side of double-sided carbon coated aluminum foil (1 mil, Exopac Advanced Coatings, Matthews N.C.) as a substrate for the layering/electrode. The dimensions of the coated area on the substrate was approximately 14 cm×15 cm. The ink formulation was sprayed through an air brush (PATRIOT 105, Badger Air-Brush Co., Franklin Park, Ill.) onto the substrate in a layer-by-layer pattern. The substrate was heated on a 70° C. hotplate for about 10 seconds following the application of every 4 layers to the substrate surface. Once all of the ink slurry mixture was sprayed onto the substrate, the layering/electrode was placed in a vacuum at a temperature of 70° C. for a period of 5 minutes. The dried layering/electrode was calendared between two steel rollers on a custom built device to a final thickness of about 1.5 mil.

FOE Preparation of IC Membrane Impregnated with Halogen Ionomer (NAFION) to Form a Coated Lithium Transport Separator:

A NAFION dispersion (˜5%, in water/1-propanol, Type D521, DuPont Company, Wilmington, Del.) was neutralized with an aqueous 2 M lithium hydroxide (Sigma-Aldrich, St Louis, Mo.) solution to pH=7.

An IC membrane was prepared from the vacated composite sheet described in example 1 above. In the prepared IC membrane, SURLYN was used as the polymer material for the LARs of the IC membrane. The SURLYN vacated composite sheet was approximately 2 mils in thickness (˜50 microns), had a porosity of about 29 volume %. As noted above, the pores in the SURLYN vacated composite sheet for receiving the NAFION were approximately 1 micron in diameter. The SURLYN vacated composite sheet was composed of a SURLYN polymer with partial sodium neutralization.

The SURLYN vacated composite sheet was cut into 1″×2″ pieces which were placed between two pieces of TEFLON mesh, and subsequently contacted with 2 M LiOH, for 2 hours at room temperature to exchange the Na⁺ with Li⁺. The lithium-exchanged SURLYN vacated composite sheet was then rinsed twice with distilled water.

A NAFION dispersion (˜5%, in water/1-propanol, Type D521, DuPont Company, Wilmington, Del.) was neutralized with an aqueous 2 M lithium hydroxide (Sigma-Aldrich, St Louis, Mo.) solution to pH=7. The NAFION dispersion containing lithium was subsequently combined with the lithium-exchanged SURLYN vacated composite sheet to form an IC membrane for incorporation in a lithium transport separator. After immersing the lithium-exchanged SURLYN vacated composite sheet in the NAFION dispersion to form an IC membrane with the modified SURLYN in the LAR(s) and the modified NAFION in the LIRs, the IC membrane was then removed from the NAFION dispersion and allowed to dry at 25° C. in air before drying in a vacuum oven for 50° C. overnight.

A Li—S coin cell was prepared using the IC membrane described above as part of a lithium transport separator for testing in the coin cell.

Preparation of Electrolyte:

In a 40 ml glass vial, 3.589 grams of lithium bis(trifluoromethanesulfonyl)imide (LiTFSI, Novolyte, Cleveland, Ohio) was combined with 20.32 grams of 1,2 dimethoxyethane (glyme, Sigma Aldrich, 259527) to create a 0.5 M electrolyte solution.

Preparation of Coin Cell:

A 14.29 mm diameter circular disk was punched from the layering/electrode and used as the positive electrode 507. The final weight of the electrode (14.29 mm in diameter, subtracting the weight of the aluminum current collector) was 3.70 mg. This corresponds to a calculated weight of 1.52 mg of elemental sulfur on the electrode.

The coin cell 500 included the positive electrode 507, a 19 mm diameter circular disk was punched from the NAFION imbibed IC membrane made by the FOE process described in the previous section. The disk was soaked overnight in glyme (Sigma Aldrich, 259527) and used as an IC membrane 506A in the coin cell 500. As depicted in FIG. 5, the IC membrane 506A is sandwiched between pieces of CELGARD 2500 separator 506B (upper and lower pieces) (Charlotte, N.C.). The components 506A and 506B (upper and lower parts) when sandwiched together form a lithium transport separator, according to an example.

The positive electrode 507, the lithium transport separator (comprising 506A and 506B (upper and lower parts)), a lithium foil negative electrode 504 (3 mils thickness, Chemetall Foote Corp., Kings Mountain, N.C., 15.88 mm in diameter) and a few electrolyte drops 505 of the nonaqueous electrolyte was sandwiched in a HOHSEN 2032 stainless steel coin cell can with a 1 mm thick stainless steel spacer disk and wave spring (Hohsen Corp.). The construction involved the following sequence as depicted in FIG. 5: bottom cap 508, positive electrode 507, electrolyte drops 505, lithium transport separator (506A and 506B, upper and lower), electrolyte drops 505, negative electrode 504, HOSHEN steel spacer 503 (1 mm in thickness), HOSHEN wave spring 502 and top cap 501. The final assembly was crimped with an MTI crimper (MTI, Richmond Calif.).

Electrochemical Testing Conditions:

The coin cell 500 was cycled at room temperature between 1.5 and 3.0 V (vs. Li/Li⁰) at C/5 (based on 1,675 mAh/g S for the charge capacity of elemental sulfur). This is equivalent to a current of 335 mAh/g S in the positive electrode 507.

Electrochemical Evaluation:

The maximum charge capacity measured on discharge at cycle 10 was 836 mAh/g S with a coulombic efficiency of 80%.

### Comparative Example A

Comparative example A demonstrates the preparation and electrochemical evaluation of a Li—S cell with a lithium transport separator according to the standard configuration using two pieces of CELGARD 2500, 0.5 M LiTFSI in glyme. No IC membrane is utilized.

Preparation of C—S Composite:

Approximately 1.0 cc of the carbon powder (KETJENBLACK EC-600JD (Akzo Nobel, Amsterdam, Netherlands) having a surface area of approximately 1400 m2/g BET (Product Data Sheet for KETJENBLACK EC-600JD, Akzo Nobel) and a pore volume of 4.07 cc/g (as measured by the BJH method) was placed in a 30 ml glass vial and loaded into an autoclave which had been charged with approximately 100 grams of elemental sulfur (Sigma Aldrich 84683, St. Louis, Mo.). The carbon powder was prevented from being in physical contact with the elemental sulfur powder, but with access of sulfur vapor to the powder. The autoclave was closed, purged with nitrogen, and then heated to 350° C. for 24 hours under a static atmosphere to develop sulfur vapor. The final sulfur content of the C—S composite was 53.5 wt. % sulfur.

Jar Milling of C—S Composite:

1.84 g of the C—S composite described above, 52.5 g of toluene (EMD Chemicals, Darmstadt, Germany) and 120 g of 5 mm diameter zirconia media were weighed into a 125 mL polyethylene bottle. The bottle was sealed, and tumbled end-over-end inside a larger jar on jar mill for 15 hours.

Preparation of Electrode Composition (C—S Composite/Binder/Carbon Black Formulation):

Polyisobutylene (PIB) with average Mw of 4,200,000 (Sigma Aldrich 181498, St. Louis, Mo.) was dissolved in toluene to produce a 2.0 wt. % polymer solution. 148 mg of SUPER C65 carbon (Timcal Ltd, Bodio, Switzerland) (BET nitrogen surface area of 62 m²/g measured by ASTM D3037-89) (Technical Data Sheet for SUPER C65, Timcal Ltd.) was dispersed in 11.3 g of the 2.0 wt % polyisobutylene solution along with 10.5 g of toluene by mechanical stirring. 44 g of the jar milled suspension of C—S composite described above was added to the SUPER C65 slurry, along with 22.6 g of toluene. This ink formulation with about 2 wt. % solid loading was mixed by stirring for 3 hours.

Spray Coating to Form Layering/Electrode:

The electrode was formed by spraying this ink formulation onto one side of a double-sided carbon coated aluminum foil (1 mil, Exopac Advanced Coatings, Matthews N.C.). The dimensions of the coated area were approximately 11 cm×11 cm. The ink formulation was sprayed through an air brush (PATRIOT 105, Badger Air-Brush Co., Franklin Park, Ill.) onto the substrate in a layer-by-layer pattern. The substrate was heated on a 70° C. hotplate for about 10 seconds following the application of every 4 layers to the substrate surface. Once all of the ink slurry mixture was sprayed onto the substrate, the electrode was placed in a 70° C. vacuum for a period of 5 minutes. The dried electrode was calendared between two steel rollers on a custom built device to a final thickness of about 1.5 mil. A coin cell was prepared using the electrode described above for testing.

Preparation of Electrolyte:

In a 40 ml glass vial, 3.589 grams of lithium bis(trifluoromethanesulfonyl)imide (LiTFSI, Novolyte, Cleveland, Ohio) was combined with 20.32 grams of 1,2 dimethoxyethane (glyme, Sigma Aldrich, 259527) to create a 0.5 M electrolyte solution.

Preparation of Coin Cell:

A 14.29 mm diameter circular disk was punched from the electrode described above and was used as a positive electrode or cathode. The final weight of the electrode (14.29 mm in diameter, subtracting the weight of the aluminum current collector) was 5.10 mg. This corresponds to a calculated weight of 2.18 mg of sulfur on the electrode.

Two pieces of CELGARD 2500 separator (Charlotte, N.C.) were used to construct the porous separator for the coin cell. The cathode, separator, a lithium foil anode (3 mils in thickness, Chemetall Foote Corp., Kings Mountain, N.C., 15.88 mm in diameter) and a few drops of the nonaqueous electrolyte were sandwiched in a HOHSEN 2032 stainless steel coin cell can (MTI, Richmond, Calif.).

The construction involved the following sequence: bottom cap, cathode (positive electrode, electrolyte drops, porous separator (with two pieces of CELGARD 2500), lithium anode (negative electrode), HOSHEN stainless steel spacer (1 mm in thickness), HOSHEN wave spring and top cap. The final assembly was crimped with an MTI crimper (MTI, Richmond Calif.).

Electrochemical Testing Conditions:

The coin cell of comparative example A was cycled at room temperature between 1.5 and 3.0 V (vs. Li/Li⁰) at C/5 (based on 1,675 mAh/g S for the charge capacity of elemental sulfur). This is equivalent to a current of 335 mAh/g S on the positive electrode (cathode). The time at charge was limited to 8 hours to allow the cell to cycle in cases where the sulfur shuttle was so large that the cell would not charge fully at the C/5 rate.

Electrochemical Evaluation:

Using this protocol, the maximum charge capacity measured on discharge at cycle 10 was 686 mAh/g S with a coulombic efficiency of 25%. Utilizing a Li—S cell incorporating one or more IC membrane(s) provides a high maximum charge capacity Li—S battery with high coulombic efficiency. Li—S cells incorporating IC membrane(s) may be utilized in a broad range of Li—S battery applications for providing a source of potential power for many household and industrial applications. The Li—S batteries incorporating IC membrane(s) are especially useful as power sources for small electrical devices such as cellular phones, cameras and portable computing devices and may also be used as power sources for car ignition batteries and for electrified cars.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

1. An ionomer composite membrane comprising:
a plurality of laterally isolated regions occupying about 0.1 to 80% by volume of the membrane and associated with pores having an average pore diameter dimension of about 0.1 to 150 microns; and
at least one laterally adjacent region;
wherein the membrane is characterized as
having an average thickness of about 3 to 500 microns,
comprising a first material and a second material,
a first region in the membrane comprises the first material and a second region comprises the second material, and
the first material comprises an ionomer.

2. The membrane of claim 1, wherein the ionomer is a halogen ionomer.

3. (canceled)

4. The membrane of claim 1, wherein the ionomer is a hydrocarbon ionomer.

5. (canceled)

6. The membrane of claim 5, wherein the copolymer of ethylene and methacrylic acid is at least partially neutralized.

7. (canceled)

8. The membrane of claim 1, wherein
the first region is a laterally isolated region,
the second region is a laterally adjacent region, and
at least one of the first region and the second region comprises a non-ionomeric polymer material.

9. (canceled)

10. The membrane of claim 1, wherein the membrane is characterized by having an average thickness of about 10 to 100 microns.

11. The membrane of claim 1, wherein the plurality of laterally isolated regions occupy about 1 to 50% by volume of the membrane.

12. The membrane of claim 1, wherein the laterally isolated regions are associated with pores having an average pore diameter dimension of about 0.5 to 75 microns.

13. (canceled)

14. (canceled)

15. The membrane of claim 1, wherein the first region comprises the ionomer in an amount of about 0.0001 to 100 mg/cm².

16. The membrane of claim 1, wherein the membrane is made from fibers according to a fiber-on-end process for making.

17. The membrane of claim 16, wherein the fibers are hollow fibers.

18. (canceled)

19. (canceled)

20. (canceled)

21. A method for making an ionomer composite membrane, comprising:
providing a set of multicomponent fibers, wherein fibers in the set have at least one center area associated with an average diameter dimension of about 0.1 to 150 microns, the set of multicomponent fibers comprising
about 20 to 99.9% by volume of at least one fiber material located around the at least one center area of respective fibers in the set, and
about 0.1 to 80% by volume of at least one sacrificial material located within the at least one center area of the respective fibers in the set;
fusing the set of fibers to form a billet;
skiving the billet to form a composite sheet having an average thickness of about 3 to 500 microns;
removing the sacrificial material from the skived composite sheet to form a vacated composite sheet with pores having an average pore diameter dimension of about 0.1 to 150 microns; and
introducing a filling material into the pores of the vacated composite sheet,
wherein at least one of the fiber material and the filling material comprises an ionomer.

22. (canceled)

23. The method of claim 21, wherein the ionomer is one of a halogen ionomer and a hydrocarbon ionomer.

24. (canceled)

25. A cell, comprising:
a positive electrode;
a negative electrode;
a circuit coupling the positive electrode with the negative electrode;
an electrolyte medium;
an interior wall of the cell; and
an ionomer composite membrane comprising an ionomer,
wherein the membrane is characterized as having
a plurality of laterally isolated regions occupying about 0.1 to 80% by volume of the membrane and associated with pores having an average pore diameter dimension of about 0.1 to 150 microns; and
at least one laterally adjacent region.

26. The cell of claim 25, wherein the membrane is characterized as
having an average thickness of about 3 to 500 microns,
comprising a first material and a second material,
a first region in the membrane comprises the first material and a second region comprises the second material, and
the first material comprises the ionomer.

27. The cell of claim 25, wherein the positive electrode comprises sulfur compound.

28. The cell of claim 25, wherein ionomer is a halogen ionomer.

29. (canceled)

30. The cell of claim 25, wherein the ionomer is a hydrocarbon ionomer.

31. (canceled)

32. The cell of claim 31, wherein the copolymer of ethylene and methacrylic acid is at least partially neutralized.

33. (canceled)

34. (canceled)

35. (canceled)

36. (canceled)

37. The cell of claim 25, wherein the cell is associated with at least one of a portable battery, a power source for an electrified vehicle, a power source for an ignition system of a vehicle and a power source for a mobile device.
